(19) United States
(12) Patent Application Publication
(10) Pub. No.: US 2025/0033361 A1
(43) Pub. Date: Jan. 30, 2025

(54) PRINTING APPARATUS

(71) Applicant: CANON KABUSHIKI KAISHA, Tokyo (JP)

(72) Inventors: KOKI SHIMADA, Kanagawa (JP); FUMIE KAMEYAMA, Tokyo (JP); YUSUKE TANAKA, Kanagawa (JP); TETSU HAMANO, Tokyo (JP)

(21) Appl. No.: 18/778,948

(22) Filed: Jul. 20, 2024

(30) Foreign Application Priority Data
Jul. 27, 2023 (JP) 2023-122835

(51) Int. Cl. B41J 2/17; B41J 2/165

(52) U.S. Cl. CPC B41J 2/1714; B41J 2/16514; B41J 2/16532

(57) ABSTRACT

To provide a printing apparatus capable of maintaining ejection performance without increasing the size of a recovery unit. The printing apparatus includes: a cap capable of covering an ejection port surface having an ejection port formed therein to eject a liquid; a cap holding portion that movably holds the cap between a position where the cap contacts the ejection port surface and a position where the cap does not contact the ejection port surface; a suction unit capable of sucking the liquid from the cap; a collection unit for collecting the liquid sucked by the suction unit; a first channel connecting the cap and the suction unit; and a second channel connecting the suction unit and the collection unit. In top view, a part of the first channel and a part of the second channel are disposed at positions overlapping with the cap holding portion.

### BACKGROUND

### Field of the Invention

The present disclosure relates to a printing apparatus.

### Description of the Related Art

A printing apparatus capable of perform printing by ejecting a liquid onto a printing medium desirably has its main body downsized.

A printing apparatus generally includes a recovery unit for recovering and keeping (maintaining) liquid ejection performance. The recovery unit includes: a suction mechanism capable of suctioning foreign matter or solidified liquid clogging ejection ports; a waste liquid collection unit for collecting the suctioned liquid as a waste liquid; and the like.

Japanese Patent Laid-Open No. 2022-107031 discloses a printing apparatus including a cap capable of covering an ejection port during maintenance, a pump capable of suctioning a liquid contained in the cap, and a waste liquid collection unit capable of collecting the suctioned liquid through a waste liquid tube. In the printing apparatus disclosed in Japanese Patent Laid-Open No. 2022-107031, the main body of the apparatus can be downsized by devising the arrangement of the waste liquid collection unit.

In the printing apparatus disclosed in Japanese Patent Laid-Open No. 2022-107031, however, the waste liquid tube is disposed along the side surface of the waste liquid collection unit. The waste liquid tube thus disposed so as to protrude in the width direction of the waste liquid collection unit leads to a possibility that the main body of the printing apparatus may be increased in size in the width direction.

### SUMMARY

An object of the present disclosure is to provide a printing apparatus capable of maintaining ejection performance without increasing the size of a recovery unit.

In an aspect of the present disclosure, there is provided a printing apparatus including: a cap configured to cover an ejection port surface having an ejection port formed therein to eject a liquid; a cap holding portion configured to movably hold the cap between a position where the cap contacts the ejection port surface and a position where the cap does not contact the ejection port surface; a suction unit configured to suck the liquid from the cap; a collection unit configured to collect the liquid sucked by the suction unit; a first channel connecting the cap and the suction unit; a second channel connecting the suction unit and the collection unit; and a channel holding portion configured to hold a part of the first channel and a part of the second channel, wherein in top view, a part of the first channel and a part of the second channel are disposed at positions overlapping with the cap holding portion.

Further features of the present disclosure will become apparent from the following description of exemplary embodiments with reference to the attached drawings.

### BRIEF DESCRIPTION OF THE DRAWINGS

FIG. 1 is a schematic diagram of a printing apparatus applicable to one embodiment;

FIG. 2 is a block diagram illustrating a control system applicable to one embodiment;

FIG. 3 is a diagram illustrating channels applicable to one embodiment;

FIG. 4 is a perspective view illustrating an example of a recovery unit applicable to one embodiment;

FIG. 5 is a diagram illustrating tube connections applicable to one embodiment;

FIG. 6 is a perspective view illustrating an example of an internal configuration of the recovery unit;

FIG. 7A is a perspective view of a configuration disposed around a cap according to one embodiment, as viewed from the front left;

FIG. 7B is a perspective view of a configuration example around the cap according to one embodiment, as viewed from the front right;

FIG. 7C is a left side view illustrating an example of a configuration disposed around the cap according to one embodiment;

FIG. 8 is a schematic top view of the recovery unit according to one embodiment;

FIG. 9 is a schematic bottom view of the recovery unit according to one embodiment;

FIG. 10A is a perspective view of a wiping mechanism applicable to one embodiment, as viewed from the front left;

FIG. 10B is a perspective view of a wiping mechanism applicable to one embodiment, as viewed from the front right;

FIG. 11A is a diagram illustrating a contracted state of a return spring according to one embodiment;

FIG. 11B is a diagram illustrating a stretched state of the return spring according to one embodiment;

FIG. 12 is a perspective view of a cam unit applicable to one embodiment;

FIG. 13 is a perspective view of a blade slider applicable to one embodiment;

FIG. 14A is a left side view illustrating an example of a wiping mechanism applicable to one embodiment;

FIG. 14B is a right side view illustrating an example of a wiping mechanism applicable to one embodiment;

FIG. 15 is a perspective view of a blade and a blade cleaner applicable to one embodiment;

FIG. 16A is a left side view of a blade holder moved forward to its limit;

FIG. 16B is a right side view of the blade holder moved forward to its limit;

FIG. 17A is a perspective view for explaining a back side configuration of the blade cleaner;

FIG. 17B is a partially enlarged view of a region XVIIb illustrated in the example of FIG. 17A;

FIG. 18A is a left side view illustrating an example of the wiping mechanism on a return path of a wiping operation;

FIG. 18B is a right side view of the wiping mechanism on the return path of the wiping operation;

FIG. 19A is a left side view illustrating an example of the wiping mechanism as the blade slider and the blade holder are returned to their initial positions;

FIG. 19B is a right side view of the wiping mechanism as the blade slider and the blade holder are returned to their initial positions;

FIGS. 20A to 20D are diagrams illustrating an operation of the wiping mechanism in the event of an abnormality;

FIG. 21 is a perspective view illustrating a second cam unit applicable to one embodiment;

FIG. 22 is a perspective view illustrating a second blade slider applicable to one embodiment;

FIGS. 23A to 23C are diagrams illustrating an operation of a second wiping mechanism in the event of an abnormality; and

FIG. 24 is a flowchart illustrating an example of wiping processing according to one embodiment.

### DESCRIPTION OF THE EMBODIMENTS

### First Embodiment

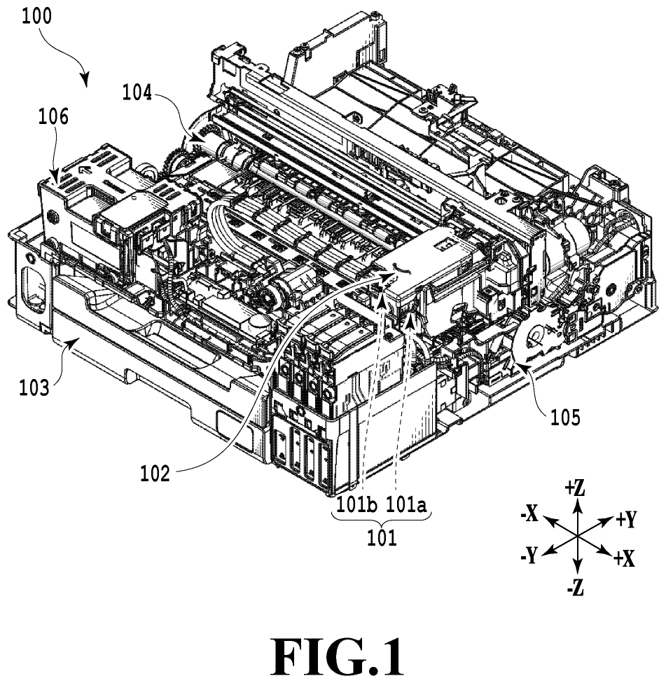

FIG. 1 is a schematic diagram of a printing apparatus 100 applicable to the present embodiment.

In the drawings referred to in this specification, an X direction and a Y direction indicate two directions orthogonal to each other on a horizontal plane. A Z direction indicates a vertical direction. In a state of facing the front of the printing apparatus, a +Y direction represents the front of the printing apparatus 100, a −Y direction represents the rear, a −X direction represents the left, a +X direction represents the right, a +Z direction represents the top, and a −Z direction represents the bottom. In the following description, unless otherwise specified, top, bottom, left, and right indicate directions as the printing apparatus 100 is used in a normal state.

In the present disclosure, “printing” does not only mean forming significant information (for example, characters or figures that are visible so that humans can visually perceive them). “Printing” also means forming insignificant information. In the present disclosure, “printing” also broadly means forming an image, design, pattern, structure, or a combination thereof on a printing medium, or processing the medium.

In the present disclosure, “printing medium” means a medium capable of accepting a liquid. An example of the printing medium is paper used for general printing apparatuses. Other examples of the printing medium include fabric, plastic films, metal plates, glass, ceramics, resin, wood, leather, and the like.

The present disclosure will be described assuming that the liquid is ink. However, the liquid applicable to the technology of the present disclosure is not limited to ink. For example, various printing liquids may be used as the liquid, including a processing liquid used for the purpose of improving ink fixability, reducing gloss unevenness, and improving scratch resistance on a printing medium.

### <Printing Apparatus 100>

As illustrated in FIG. 1, the printing apparatus 100 includes a printing head configured to be able to eject ink onto a printing medium. In the present embodiment, a head cartridge 101 is used as the printing head. The head cartridge 101 according to the present embodiment includes a first head cartridge 101a and a second head cartridge 101b. The first head cartridge 101a and the second head cartridge 101b will be hereinafter referred to as the head cartridge 101 unless there is a particular need to distinguish between the two. The head cartridge 101 is configured to be detachable from a carriage 102.

The first head cartridge 101a can contain and eject a first type of liquid (for example, black ink). The second head cartridge 101b can contain and eject a second type of liquid. In the present embodiment, the second head cartridge 101b can contain and eject three types of color ink: yellow, magenta, and cyan. Note that the first head cartridge 101a and the second head cartridge 101b may be configured to be able to contain and eject the same type of liquid.

The first head cartridge 101a and the second head cartridge 101b each include a printing element substrate (not illustrated) capable of ejecting ink supplied from an ink storage unit through a channel. Each printing element substrate includes an electrothermal conversion element (for example, a heater, not illustrated) as an ejection energy generating element (pressure generating element) configured to generate energy for ejecting an ink liquid filled in a pressure chamber. The electrothermal conversion element, together with an ejection port (not illustrated) and the pressure chamber (not illustrated), is located closer to an outflow channel than to a supply channel. For example, the electrothermal conversion element is driven to generate heat to generate bubbles in the ink filled in the pressure chamber (not illustrated). This bubble generating energy can be used to eject ink droplets from the ejection port (not illustrated). Note that other examples of the ejection energy generating element applicable to the present embodiment include a piezoelectric element and the like.

The printing apparatus 100 includes a feeder (not illustrated) having a mechanism capable of feeding printing media loaded in a cassette 103 one by one, and a conveyance unit 104 capable of conveying the printing medium fed from the feeder. The printing apparatus 100 includes a recovery unit 105 for maintaining and recovering ejection performance of the head cartridge 101 mounted on the carriage 102. The printing apparatus 100 includes a waste liquid collection unit 106 disposed at one end (end on the −X direction side in the present embodiment) of the carriage 102 in a scanning direction (+X direction).

The recovery unit 105 is disposed at the other end (end on the +X direction side in the present embodiment) of the carriage 102 in the scanning direction. Various mechanisms included in the recovery unit 105 operate by receiving driving force transmitted through a chain of drives from a drive source included in the conveyance unit 104. The ink discharged from the recovery unit 105 during maintenance is collected by the waste liquid collection unit 106. Note that “maintenance” refers to an operation for maintaining and recovering good ejection performance of the head cartridge 101.

The printing medium fed one by one from the feeder is conveyed in a conveyance direction (−Y direction) by the conveyance unit 104. With the head cartridge 101 mounted on the carriage 102, printing is performed by ejecting droplets from the head cartridge 101 onto the conveyed printing medium while the carriage 102 reciprocates in the scanning direction.

In an printing operation by the printing apparatus 100, the head cartridge 101 mounted on the carriage 102 starts printing from the side where the recovery unit 105 is disposed. The carriage 102 then moves to the side where the waste liquid collection unit 106 is disposed. The carriage 102 turns around on the side where the waste liquid collection unit 106 is disposed and returns to the side where the recovery unit 105 is disposed. The carriage 102 repeats such a reciprocating operation multiple times. The ejection operation from the head cartridge 101 accompanying the reciprocating operation of the carriage 102 and the conveyance operation by the conveyance unit 104 are alternately repeated to perform printing gradually on the entire surface of the printing medium.

The recovery unit 105 is disposed outside the range in which the carriage 102 with the head cartridge 101 mounted thereon reciprocates for the printing operation (that is, outside a printing area in the X direction). The recovery unit 105 may be disposed in a desired position outside the printing area. In the following description, a position within a movement area where the carriage 102 can move and outside the printing area, where a maintenance operation can be performed by the recovery unit 105, will be referred to as a home position. The recovery unit 105 forcibly sucks ink from the ejection port of the head cartridge 101 and discharges the ink. By thus discharging the ink, the ink thickened inside a channel formed in the head cartridge 101 and air bubbles or the like in the channel can be removed.

During maintenance of the head cartridge 101, ink that does not contribute to image printing may be ejected from the ejection port (hereinafter also referred to as “preliminary ejection”) in order to keep the head in a good ejection state. In this event, the recovery unit 105 collects the preliminarily ejected ink. In a state where the head cartridge 101 is not performing printing, the recovery unit 105 can protect the head cartridge 101 by covering the ejection port surface of the head cartridge 101, and can also prevent the ink from drying.

### <Control System of Printing Apparatus 100>

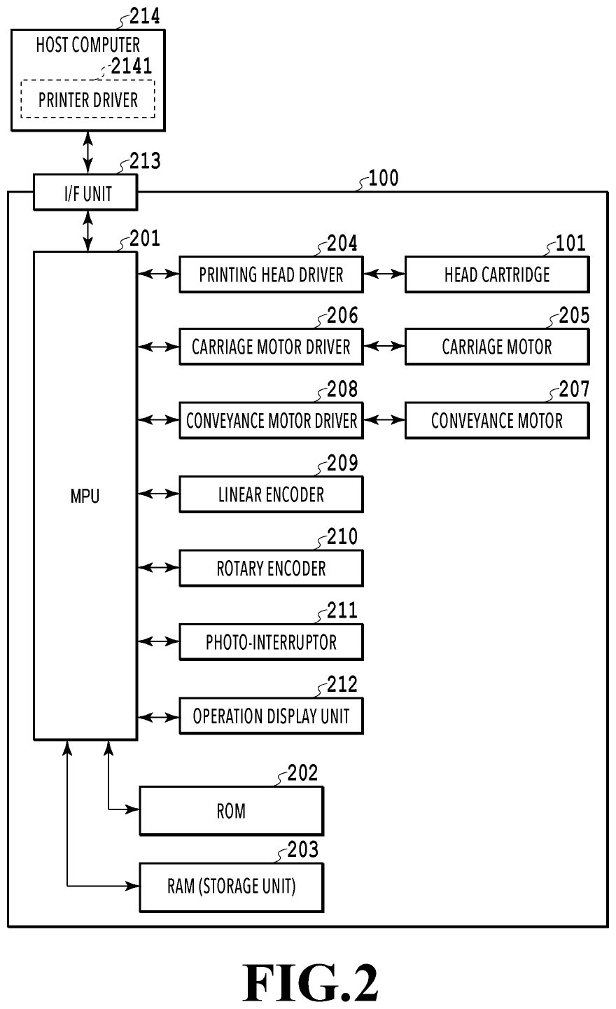

FIG. 2 is a block diagram illustrating a control system of the printing apparatus 100 according to the present embodiment.

As illustrated in FIG. 2, the printing apparatus 100 includes an MPU 201 for controlling the entire apparatus, a ROM 202 storing programs to be executed by the MPU 201 and various parameters, and a RAM 203 that can be used as a storage unit.

The printing apparatus 100 includes a printing head driver 204 for driving the head cartridge 101. The printing apparatus 100 includes a carriage motor 205 for driving a carriage and a carriage motor driver 206 for controlling the carriage motor 205. The printing apparatus 100 includes a conveyance motor 207 for driving the conveyance unit and a conveyance motor driver 208 for controlling the conveyance motor 207. A conveyance roller and a discharge roller included in the conveyance unit are driven by the conveyance motor 207.

The printing apparatus 100 includes a linear encoder 209 capable of detecting the position of the carriage 102. The printing apparatus 100 includes a rotary encoder 210 capable of detecting a rotation angle of the conveyance unit 104. The printing apparatus 100 includes a photo-interruptor 211 capable of detecting a rotation angle of a cam unit (to be described later) included in the recovery unit 105. The printing apparatus 100 includes an operation display unit 212 used to operate the printing apparatus 100.

The printing apparatus 100 includes an interface (I/F) unit 213 for transmitting and receiving various data to and from an external apparatus. In the present embodiment, the I/F unit 213 is configured to be able to transmit and receive various data to and from a host computer 214 including a printer driver 2141.

The MPU 201 is configured to be able to control the entire apparatus, such as the operation of each unit and data processing. The ROM 202 is configured to be able to store programs to be executed by the MPU 201 and various data. The RAM 203 temporarily stores data processed by the MPU 201 and data received from the host computer 214.

The operation display unit 212 includes an input unit (for example, a numerical input key, a mode setting key, an enter key, a cancel key, and the like) capable of accepting operations inputted by a user, and a display unit such as a light emitting diode (LED). Information inputted by the user is sent to the MPU 201. The display unit of the operation display unit 212 is configured to be able to display the information sent from the MPU 201. The printer driver 2141 is installed in the host computer 214 to collect and communicate printing information such as a printed image and the quality of the printed image with the printing apparatus 100, in a case where the user instructs execution of a printing operation. The MPU 201 exchanges the printed images and the like with the host computer 214 through the I/F unit 213.

### <Channels in Recovery Unit 105>

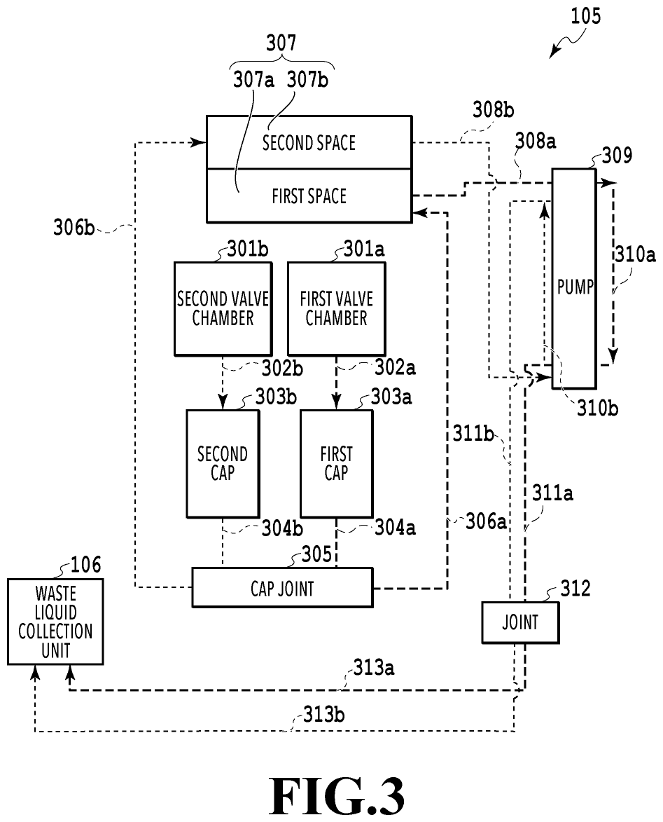

FIG. 3 is a diagram illustrating channels in the recovery unit 105 according to the present embodiment. The recovery unit 105 includes a first channel for sucking and collecting black ink from the first head cartridge 101a (see FIG. 1) during maintenance. The recovery unit 105 includes a second channel for sucking and collecting color ink from the second head cartridge 101b (see FIG. 1).

As illustrated in FIG. 3, the recovery unit 105 includes a first valve chamber 301a provided with an air valve seal (not illustrated) made of an elastic member (for example, rubber or the like). One end of a tube 302a is connected to the first valve chamber 301a. The other end of the tube 302a is connected to a first cap 303a capable of covering the ejection port surface of the first head cartridge 101a.

One end of a tube 304a for collecting the black ink is connected to the first cap 303a. The other end of the tube 304a is connected to a cap joint 305.

One end of a tube 306a for collecting the black ink is connected to the connection part of the cap joint 305.

The other end of the tube 306a is connected to an air buffer 307 whose internal volume can be changed. The air buffer 307 has a first space 307a capable of storing the black ink and a second space 307b capable of storing the color ink. The other end of the tube 306a is connected to the first space 307a.

One end of a tube 308a for collecting the black ink is connected to the first space 307a. The other end of the tube 308a is connected to one end of a tube 310a disposed on the upstream side of a pump 309 configured to be able to suck the black ink and color ink. The other end of the tube 310a is connected to one end of a tube 311a disposed on the downstream side of the pump 309 and configured to collect the black ink. The other end of the tube 311a is connected to a joint 312 having a plurality of connection parts to which the ends of one tube can be connected.

One end of a tube 313a for collecting the black ink is connected to the connection part of the joint 312. The other end of the tube 313a is connected to the waste liquid collection unit 106 capable of storing the black ink and color ink discharged to the outside of the first head cartridge 101a during maintenance.

The recovery unit 105 includes a second valve chamber 301b provided with an air valve seal (not illustrated) made of an elastic member (for example, rubber or the like). The first valve chamber 301a and the second valve chamber 301b will be hereinafter referred to as the “valve chamber 301” unless there is a particular need to distinguish between the two. An end of a tube 302b is connected to the second valve chamber 301b. The other end of the tube 302b is connected to a second cap 303b capable of covering the ejection port surface of the second head cartridge 101b. The first cap 303a and the second cap 303b will be hereinafter referred to as the “cap 303” unless there is a particular need to distinguish between the two.

One end of a tube 304b for collecting the color ink is connected to the second cap 303b. The other end of the tube 304b is connected to the cap joint 305. Note that the cap joint 305 includes a plurality of connection parts for connecting tubes, and the black ink and the color ink do not mix inside the cap joint 305.

One end of a tube 306b for collecting the color ink is connected to the connection part of the cap joint 305. The other end of the tube 306b is connected to the second space 307b. The tube 306a and the tube 306b will be hereinafter referred to as the “tube 306” unless there is a particular need to distinguish between the two.

One end of a tube 308b for collecting the color ink is connected to the second space 307b. The other end of the tube 308b is connected to one end of a tube 310b disposed on the upstream side of the pump 309. The other end of the tube 310b is connected to one end of a tube 311b disposed on the downstream side of the pump 309 and configured to collect the color ink. The other end of the tube 311b is connected to the joint 312. The tube 308a and the tube 308b will be hereinafter referred to as the “tube 308” unless there is a particular need to distinguish between the two.

One end of a tube 313b for collecting the color ink is connected to the connection part of the joint 312. The other end of the tube 313b is connected to the waste liquid collection unit 106. The tube 313a and the tube 313b will be hereinafter referred to as the “tube 313” unless there is a particular need to distinguish between the two.

### <Recovery Unit 105>

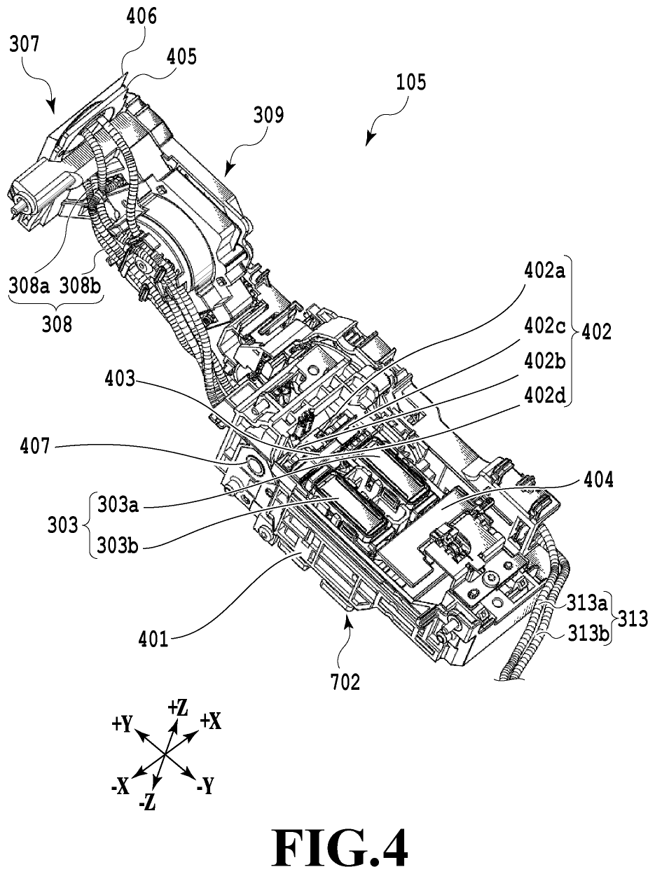

FIG. 4 is a perspective view illustrating an example of the recovery unit 105 applicable to the present embodiment.

As illustrated in FIG. 4, a cap holding portion (to be described later) capable of holding the cap 303 and a suction unit (for example, the pump 309) are arranged side by side along a depth direction (Y direction) of the printing apparatus.

The recovery unit 105 according to the present embodiment includes a base 401 that serves as a structural member. A tube holding portion 702 is fixed to the base 401. The tube holding portion 702 fixed to the base 401 prevents deformation of the base 401. With such a configuration, sliding resistance with respect to the base 401 in a case where the cap holding portion moves up and down is reduced compared to the case where the deformation of the base 401 is not suppressed. Reducing the sliding resistance between the cap holding portion and the base contributes to the stability of the vertical movement of the cap holding portion. The cap 303 has a shape that can receive ink discharged to the outside of the head cartridge 101 while covering the ejection port surface.

The recovery unit 105 includes a first blade 402a, a second blade 402b, a third blade 402c, and a fourth blade 402d, which are capable of wiping the ejection port surface of the head cartridge 101. The first blade 402a, the second blade 402b, the third blade 402c, and the fourth blade 402d will be hereinafter referred to as the “blade 402” unless there is a particular need to distinguish between them.

The first blade 402a and the third blade 402c can wipe the ejection port surface of the first head cartridge 101a. The third blade 402c can wipe the entire area of the ejection port surface of the first head cartridge 101a. The first blade 402a can wipe the ejection port array and its vicinity on the ejection port surface of the first head cartridge 101a.

The second blade 402b and the fourth blade 402d can wipe the ejection port surface of the second head cartridge 101b. The fourth blade 402d can wipe the entire area of the ejection port surface of the second head cartridge 101b. The second blade 402b can wipe the ejection port array and its vicinity on the ejection port surface of the second head cartridge 101b.

The recovery unit 105 includes a blade holder 403 that can reciprocate along the longitudinal direction (Y direction) of the ejection port surface while holding the blade 402. The recovery unit 105 includes a blade cleaner 404 that can scrape off ink adhering to the blade 402. As the blade 402 moves in the Y direction and comes into contact with the blade cleaner 404, the ink adhering to the blade 402 is scraped off, thus preventing the ink from being transferred again to the ejection port surface and the ejection port.

The air buffer 307 is disposed in the middle of the channel connecting between the cap 303 and the pump 309. The air buffer 307 includes a case 405 and a flexible film 406 welded to the case 405. Each end of tubes 306a, 306b, 308a, and 308b is connected to the case 405.

The recovery unit 105 includes a cam unit 407 that can be rotated by driving the conveyance motor 207 (see FIG. 2).

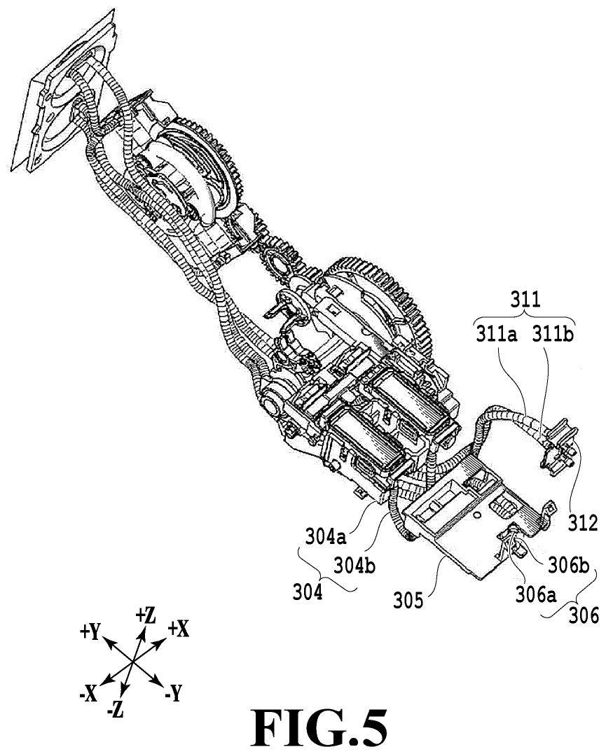

FIG. 5 is a diagram illustrating the connection between the tube 304 and the tube 306.

As illustrated in FIG. 5, the tube 304 is connected to the tube 306 through the cap joint 305. In other words, the cap joint 305 is configured to allow the ink flowing in from the tube 304 to flow out into the tube 306.

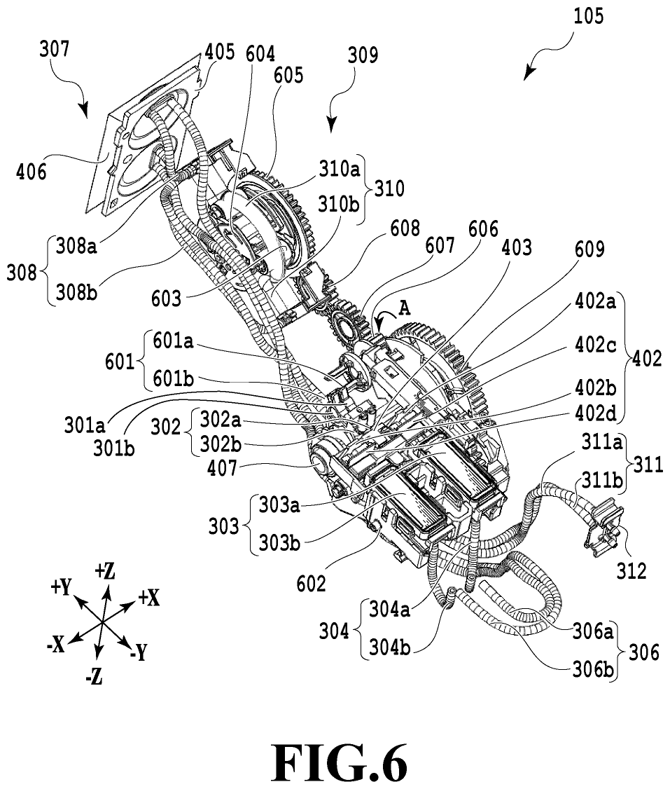

FIG. 6 is a perspective view illustrating the internal configuration of the recovery unit 105. FIG. 6 does not illustrate the cap joint to facilitate the understanding of the connection relationship between the tube 304 and the tube 306.

As illustrated in FIG. 6, the recovery unit 105 includes an air valve lever 601 that can switch between a communication state where the inside of the cap 303 is communicated with the atmosphere, and a non-communication state where the inside of the cap 303 is not communicated with the atmosphere. The air valve lever 601 includes a first lever 601a and a second lever 601b.

The first lever 601a can switch between a communication state where the inside of the first cap 303a is communicated with the atmosphere, and a non-communication state where the inside of the first cap 303a is not communicated with the atmosphere. The second lever 601b can switch between a communication state where the inside of the second cap 303b is communicated with the atmosphere, and a non-communication state where the inside of the second cap 303b is not communicated with the atmosphere. The first lever 601a and the second lever 601b will be hereinafter referred to as the “air valve lever 601” unless there is a particular need to distinguish between the two. Specifically, in a case where the first lever 601a is in contact with an air valve seal (not illustrated) disposed in the first valve chamber 301a, the inside of the first cap 303a is not communicated with the atmosphere. In a case where the second lever 601b is in contact with an air valve seal (not illustrated) disposed in the second valve chamber 301b, the inside of the second cap 303b is not communicated with the atmosphere.

The recovery unit 105 includes a cap holding portion 602 capable of holding the first cap 303a and the second cap 303b. By engaging a guide (not illustrated) provided on the base with a part of the cap holding portion 602, the cap holding portion 602 moves up and down along the guide. This vertical movement of the cap holding portion 602 allows the cap 303 to be switched between a capping state where the ejection port surface is covered and a release state where the capping state is released.

By engaging a guide (not illustrated) provided on the base with a part of the blade holder 403, the blade holder 403 reciprocates along the guide in the longitudinal direction of the ejection port surface. This reciprocal movement of the blade holder 403 allows the ejection port surface to be wiped by the blade 402. A blade cleaner (not illustrated here) is disposed at the end (end on the −Y direction side) of the forward path of the blade holder 403.

The pump 309 includes a roller 603 that can press the tube 310a and the tube 310b. The tube 310a and the tube 310b will be hereinafter referred to as the “tube 310” unless there is a particular need to distinguish between the two. The roller 603 is held by a roller holding portion 604. The roller holding portion 604 has a rotation shaft. The rotation shaft of the roller holding portion 604 is located at the center of the arc on an arc-shaped guide surface. A pump gear 605 for rotating the pump 309 is fixed to the roller holding portion 604.

Various recovery operations in the recovery unit 105 are controlled by the rotation of the conveyance motor 207 (see FIG. 2). The driving force generated by the rotation of the conveyance motor 207 is transmitted to an input gear 606 through a one-way clutch gear. In a case of rotating the pump 309, forward rotation of the conveyance motor 207 causes the one-way clutch gear to idle and the input gear 606 to rotate forward (rotate in the direction indicated by arrow A). On the other hand, in a case of rotating the cam unit 407, backward rotation of the conveyance motor 207 causes the one-way clutch gear to mesh and the input gear 606 to rotate backward (rotate in the direction opposite to the direction indicated by arrow A).

The input gear 606 meshes with a gear 607 for rotating the pump 309 and a gear 609 fixed to the cam unit 407. A gear 608 for rotating the pump 309 meshes with the gear 607. A pump gear 605 meshes with the gear 608.

In a case of rotating the pump 309, the driving force of the conveyance motor 207 is transmitted to the input gear 606, gear 607, gear 608, and pump gear 605. As the pump gear 605 rotates (in the direction indicated by arrow A), the roller holding portion 604 also rotates, causing the roller 603 to press the tubes 310a and 310b.

As the tube 310a is pressed by the roller 603 with the ejection port surface of the first head cartridge 101a capped by the first cap 303a, black ink is sucked from the ejection port surface. As the tube 310b is pressed by the roller 603 with the ejection port surface of the second head cartridge 101b capped by the second cap 303b, color ink is sucked from the ejection port surface.

In the present embodiment, a one-way clutch (not illustrated) is idling while the pump 309 is rotating. The cam unit 407 does not rotate while the one-way clutch gear is idling. That is, the cap 303, the blade 402, and the air valve lever 601 do not operate while the pump 309 is rotating.

In a case of rotating the cam unit 407, on the other hand, the input gear 606 rotates backward, causing the one-way clutch gear to mesh. In this meshing state of the one-way clutch gear, the cap 303, the blade 402, and the air valve lever 601 can operate at predetermined timing. The recovery unit 105 according to the present embodiment is thus configured so that the roller 603 does not press the tube 310a and the tube 310b while the cap 303, the blade 402, and the air valve lever 601 are in operation.

In the air buffer 307, the first space 307a (see FIG. 3) and the second space 307b are formed by welding the film 406 to the case 405. The first space 307a can store the black ink. The second space 307b can store the color ink. In a case where the conveyance motor 207 is rotated backward after the pump 309 is driven to suck the ink, bubbles may be generated in the ink remaining inside the cap 303. To counter this, such generation of bubbles can be suppressed by deforming the flexible film 406 and changing the volume inside the air buffer 307.

In the present embodiment, the waste liquid collection unit 106 (see FIG. 1), the cap holding portion 602, and the pump 309 are arranged in this order from the front along the depth direction (Y direction) of the printing apparatus 100. With such arrangement, the tubes connecting these can be arranged along the Y direction, and most of the tubes can be accommodated within the width of the recovery unit 105. Therefore, by arranging the waste liquid collection unit 106, the cap holding portion 602, and the pump 309 in this order, the recovery unit 105 can be made smaller (thinner) in the direction (X direction) in which the carriage 102 (see FIG. 1) moves. This makes it possible to reduce the size of the entire apparatus.

In the present embodiment, the first lever 601a and the second lever 601b are each configured to be able to rotate independently. With this configuration, sucking the black ink only, sucking the color ink only, and sucking the black ink and the color ink at the same time can be selectively executed. Furthermore, by releasing the cap 303 before suction, the suction can be performed to discharge the ink remaining inside the cap 303 to the outside without consuming the ink inside the head cartridge.

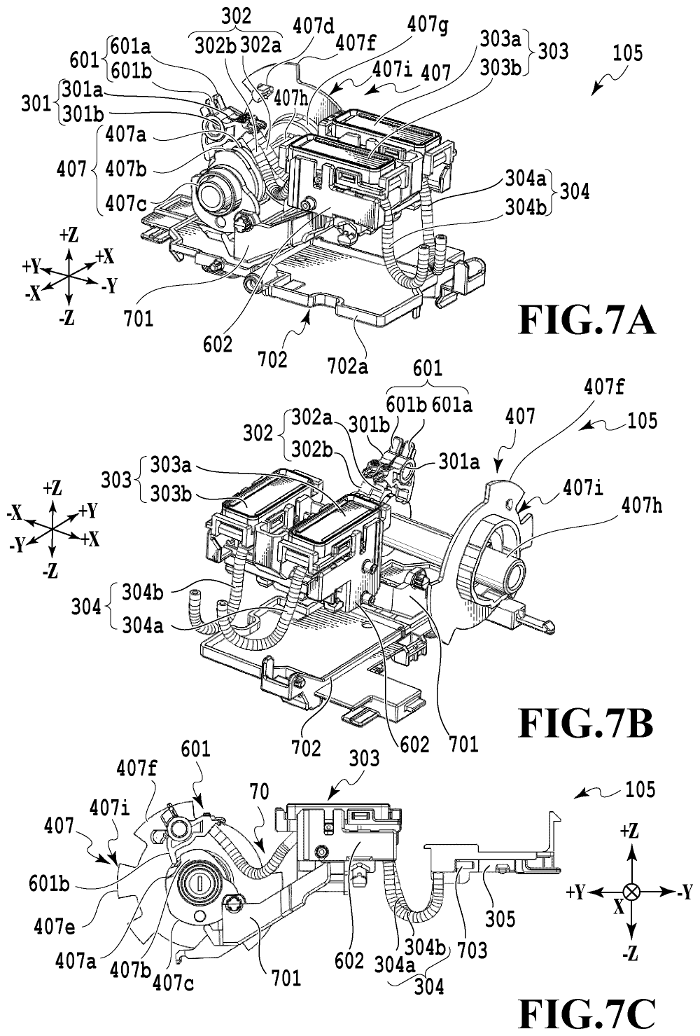

FIG. 7A is a perspective view of a configuration disposed around the cap 303 in the present embodiment, as viewed from the front left.

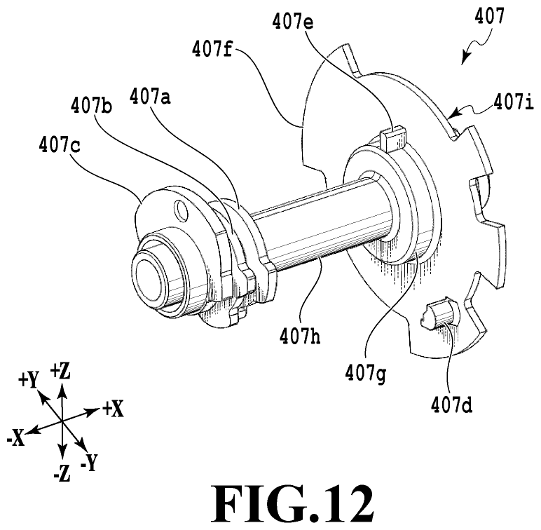

As illustrated in FIG. 7A, the cam unit 407 includes a main cam 407i, a thick shaft portion 407g, a thin shaft portion 407h, a first cam 407a, a second cam 407b, and a third cam 407c. The main cam 407i includes a first pressing portion 407d, a second pressing portion 407e (see FIG. 12), and a sensor flag 407f.

A rotation shaft included in the cam unit 407 includes the thick shaft portion 407g located at a base end (end on the +X direction side) and the thin shaft portion 407h having a smaller diameter than the thick shaft portion 407g. The thin shaft portion 407h extends from the center of the thick shaft portion 407g in a direction (−X direction) orthogonal to the left side surface of the thick shaft portion 407g. At the leading end (end on the −X direction side) of the thin shaft portion 407h, the first cam 407a, the second cam 407b, and the third cam 407c are formed in this order from the base end to the leading end.

The first cam 407a has a shape that allows the first lever 601a to be pressed by rotating the cam unit 407. As the cam unit 407 rotates and the first cam 407a presses the first lever 601a, the rotation operation of the cam unit 407 is converted into the rotation operation of the first lever 601a.

The second cam 407b has a shape that allows the second lever 601b to be pressed by rotating the cam unit 407. As the cam unit 407 rotates and the second cam 407b presses the second lever 601b, the rotation operation of the cam unit 407 is converted into the rotation operation of the second lever 601b.

A base end (end on the +Y direction side) of an arm 701 that can support the cap holding portion 602 in a vertically movable manner is fixed to the third cam 407c. A leading end of the arm 701 (end on the −Y direction side) is fixed to the cap holding portion 602. As the cam unit 407 rotates, the rotation operation of the cam unit 407 is converted into an elevating and lowering operation of the cap holding portion 602.

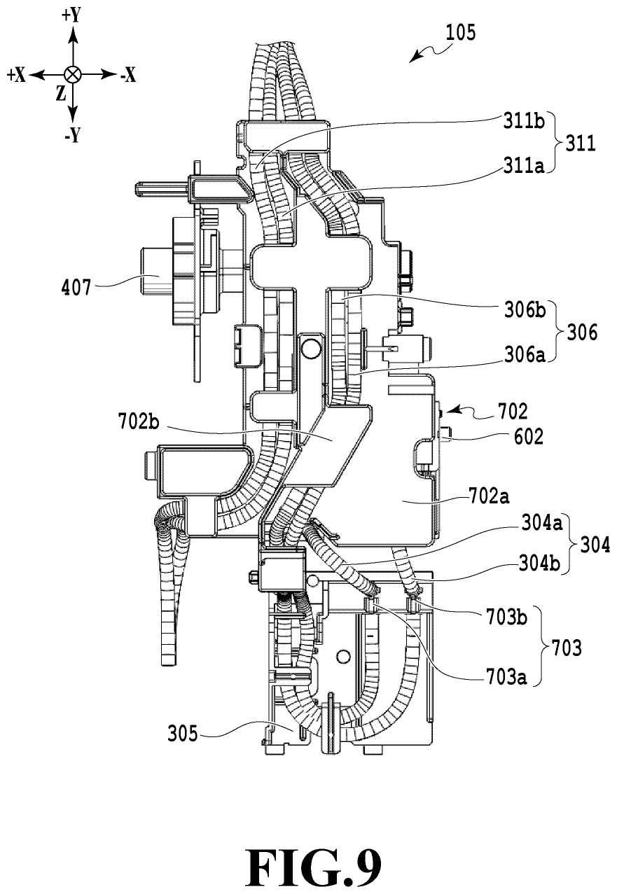

The tube holding portion 702 is disposed below the cap holding portion 602 in the vertical direction (−Z direction). Note that how the tube is held by the tube holding portion 702 will be described later. The tube holding portion 702 includes an upper plate 702a having a surface facing the cap holding portion 602 and a lower plate 702b positioned below the upper plate in the vertical direction (see FIG. 9). The upper plate 702a has a tray shape. Specifically, a wall extending upward in the vertical direction is formed on the outer periphery of the upper plate 702a. Note that the wall may be formed at an obtuse or acute angle with respect to the outer periphery of the upper plate 702a, or may be a curved surface, as long as it can catch ink dripping from the cap holding portion 602.

With the tube holding portion 702 having such a wall, even if ink drips from the cap holding portion 602 for some reason, the dripping ink is caught by the area surrounded by the wall. The ink dripping from the cap holding portion 602 can thus be prevented from leaking to the outside of the apparatus main body.

FIG. 7B is a perspective view of a configuration example around the cap 303 according to the present embodiment, as viewed from the front right.

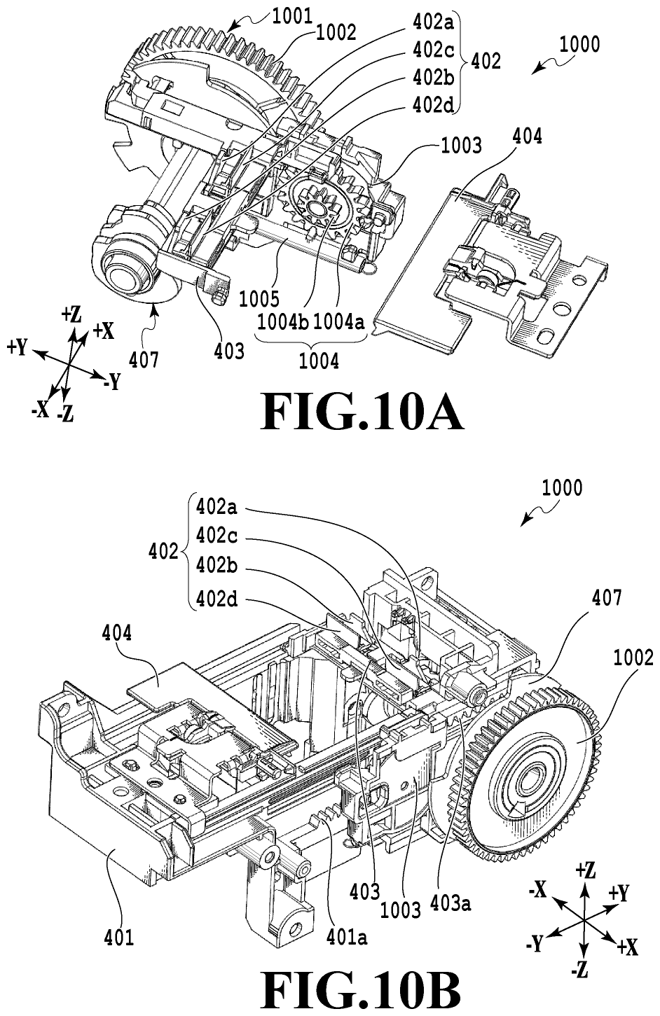

As illustrated in FIG. 7B, the thin shaft portion 407h of the cam unit 407 extends so as to penetrate the main cam 407i of the cam unit 407. The right side surface of the main cam 407i in the cam unit 407 is configured to allow attachment of a main gear 1002 (see FIGS. 10A and 10B).

FIG. 7C is a left side view illustrating a configuration example around the cap 303 according to the present embodiment.

As illustrated in FIG. 7C, the cap holding portion 602 is configured to be movable up and down between a position where the cap 303 is brought into close contact with the ejection port surface and a position where the cap 303 is separated from the ejection port surface.

Specifically, one end of the tube 304 (end on the +Y direction side) is connected so as to extend downward in the vertical direction from the cap 303. The tube 304 is bent in a U-shape such that the other end (end on the −Y direction side) of the tube 304 faces upward in the vertical direction. The other end of the tube 304 is also connected from below to the cap joint 305 disposed on the −Y direction side with respect to the cap holding portion 602.

The cap joint 305 includes a connection part extending downward in the vertical direction. The other end of the tube 304 is connected to the connection part so as to face upward in the vertical direction.

With this connection of the tube 304, the reaction force of the tube 304 generated as the cap holding portion 602 moves up and down is reduced compared to the case where one end of the tube 304 is connected linearly along the horizontal direction (for example, the Y direction) from the cap 303. By reducing the reaction force of the tube 304, operation failure of the cap holding portion 602 can be suppressed compared to the case where one end of the tube 304 is connected linearly along the horizontal direction (for example, the Y direction) from the cap 303.

By suppressing operation failure of the cap holding portion 602, the cap 303 can be lifted with high precision to cover the ejection port surface. The cap 303 can also be lowered with high precision to release the covered state of the ejection port surface.

The cap joint 305 also includes a connection part 703 extending along the depth direction (Y direction) of the printing apparatus 100. One end of the tube 306 (see FIG. 5) is connected to the connection part 703. This connection of the tube 306 (see FIG. 5) can contribute to miniaturization of the recovery unit in the width direction, compared to the case where the tube 306 (see FIG. 5) is connected so as to extend from the cap joint 305 in the width direction (X direction).

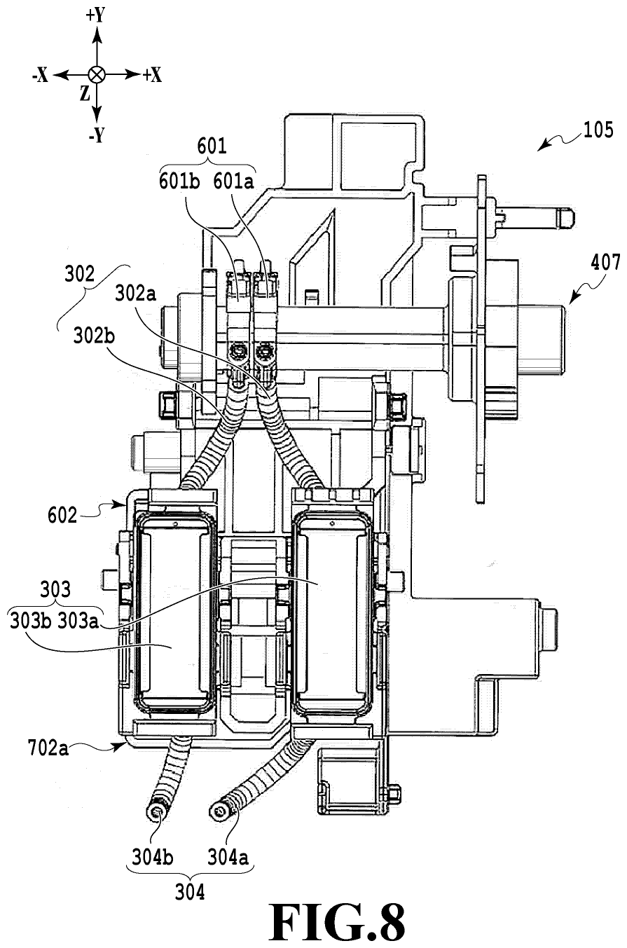

FIG. 8 is a schematic top view of the recovery unit 105 according to the present embodiment.

As illustrated in FIG. 8, the recovery unit 105 is arranged such that, in top view, the tubes 302 and 304 are accommodated within the width (length in the X direction) of the upper plate 702a. Such arrangement can suppress an increase in width (length in the X direction) of the recovery unit 105, compared to the arrangement in which the tube 302 and the tube 304 extend from the cap 303 in the width direction (X direction).

FIG. 9 is a schematic bottom view of the recovery unit 105 according to the present embodiment.

As illustrated in FIG. 9, the tube 306 extends along the depth direction (Y direction) of the printing apparatus 100 so as to be sandwiched between the bottom surface (surface facing the −Z direction) of the upper plate 702a and the upper surface (surface facing the +Z direction) of the lower plate 702b. The tube 311 includes a portion disposed in parallel with the tube 306 along the Y direction from the pump 309, and a portion separated from the tube holding portion 702 and connected to the waste liquid collection unit 106 (see FIG. 1). The tube 306 and the tube 311 are each partly arranged so as to extend along the Y direction in a horizontal plane and to be lined up along a direction intersecting the Y direction.

The connection part 703 is formed on the bottom surface of the cap joint 305 according to the present embodiment. The connection part 703 includes a first connection part 703a that can supply the ink supplied from the tube 304a to the tube 306a and a second connection part 703b that can supply the ink supplied from the tube 304b to the tube 306b. The first connecting part 703a and the second connecting part 703b will be hereinafter referred to as the “connection part 703” unless there is a particular need to distinguish between the two.

The tube 304a is connected to the tube 306a through the first connection part 703a. The tube 304b is connected to the tube 306b through the second connection part 703b. At the bottom of the cap joint 305, the tube 306 is arranged so as to change its direction from the −Y direction to the +Y direction without protruding from the width (length in the X direction) of the cap joint 305.

The tube holding portion 702 includes the upper plate 702a and the lower plate 702b disposed below the upper plate 702a in the vertical direction. The tube 306 and the tube 311 are sandwiched between the upper plate 702a and the lower plate 702b, and are thus fixed to the tube holding portion 702.

Specifically, below the cap holding portion 602 in the vertical direction, the tube 306 and the tube 311 are arranged in parallel so as not to protrude from the width of the lower plate 702b along the width direction (X direction) of the lower plate 702b.

That is, in the present embodiment, the tube 306 is part of a first channel that connects the cap 303 and the pump 309. The tube 311 is part of a second channel that connects the pump 309 (see FIG. 3) and the waste liquid collection unit 106. In bottom view (viewed from the −Z direction), the tube 306 and the tube 311 are arranged so as to overlap the lower plate 702b. It also goes without saying that, in plan view (viewed from the +Z direction), the tube 306 and the tube 311 are arranged so as to overlap the lower plate 702b.

With such arrangement, a plurality of tubes can be arranged together without increasing the width (length in the X direction). Therefore, compared to the case where the tubes are arranged along the width direction of the recovery unit 105 so as to avoid the cap, the arrangement of the tubes according to the present embodiment makes it possible to downsize the recovery unit 105 in the width direction (X direction).

The printing apparatus according to the present embodiment can thus maintain the ejection performance without increasing the size of the recovery unit.

### <Wiping Operation>

FIG. 10A is a perspective view of a wiping mechanism 1000 applicable to the present embodiment, as viewed from the front left.

As illustrated in FIG. 10A, the wiping mechanism 1000 includes a blade driving mechanism 1001 for driving the blade 402 and the blade cleaner 404 capable of scraping off deposits (for example, ink) adhering to the blade 402. The blade driving mechanism 1001 includes the cam unit 407, the main gear 1002 attached to the cam unit 407, the blade holder 403, and the blade 402. The main gear 1002 rotates as the driving force of the conveyance motor 207 (see FIG. 2) is transmitted to the main gear 1002. The cam unit 407 rotates as the main gear 1002 rotates.

The blade driving mechanism 1001 includes a blade slider 1003 that can be moved by engaging with the cam unit 407, and a two-stage gear 1004 that is rotatably attached to the blade slider 1003. The two-stage gear 1004 includes a first gear 1004a and a second gear 1004b having the same rotation axis. The blade driving mechanism 1001 includes a return spring 1005 that has elasticity.

FIG. 10B is a perspective view of the wiping mechanism 1000 applicable to the present embodiment, as viewed from the front right.

As illustrated in FIG. 10B, a first rack 403a that can mesh with the first gear 1004a (see FIG. 10A) is formed in a part of the blade holder 403. A second rack 401a that can mesh with the second gear 1004b (see FIG. 10A) is fixed to the base 401. The return spring 1005 is disposed between the blade slider 1003 and the base 401.

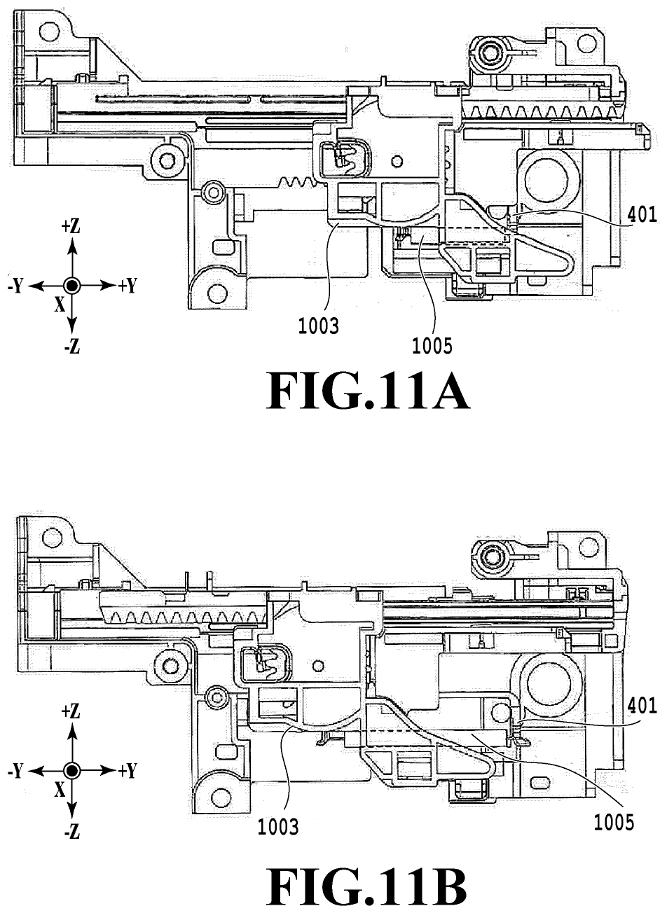

FIG. 11A is a diagram illustrating a contracted state of the return spring 1005 according to the present embodiment.

As illustrated in FIG. 11A, one end of the return spring 1005 is fixed to the base 401. The other end of the return spring 1005 is fixed to the blade slider 1003.

FIG. 11B is a diagram illustrating a stretched state of the return spring 1005 according to the present embodiment. As illustrated in FIG. 11B, on the forward path of the wiping operation, the conveyance motor 207 (see FIG. 2) rotates in one direction, causing the blade slider 1003 to move forward (in the −Y direction) while stretching the return spring 1005. The blade can thus wipe the ejection port surface of the head cartridge while moving substantially parallel to the ejection port surface.

On the return path of the wiping operation, the blade slider 1003 can move backward (move in the +Y direction) using the elastic restoring force of the return spring 1005. The blade 402 (see FIG. 10B) can thus return to its initial position while being biased by the return spring 1005. Specifically, with such a configuration, the blade 402 can perform a reciprocating operation of wiping the ejection port surface of the head cartridge 101 (see FIG. 1) while moving substantially parallel to the ejection port surface, and returning to the initial position while being biased by the return spring 1005.

### <Cam Unit 407>

FIG. 12 is a perspective view illustrating an example of the cam unit 407 applicable to the present embodiment.

As illustrated in FIG. 12, the thick shaft portion 407g that functions as a rotation shaft extends from the center of the left side surface (surface facing the −X direction) of the main cam 407i toward the inside of the cam unit 407. The thin shaft portion 407h having a smaller diameter than the thick shaft portion 407g extends from the center of the left side surface (surface facing the −X direction) of the thick shaft portion 407g in the same direction as the direction in which the thick shaft portion 407g extends.

The second pressing portion 407e that can press the blade slider 1003 is formed from the outer peripheral surface of the thick shaft portion 407g so as to contact the left side surface of the main cam 407i. The second pressing portion 407e can press the blade slider 1003 (see FIG. 10B) as the cam unit 407 rotates. As will be described in detail later, unexpected load may act on the blade 402 (see FIG. 10B) on the return path of the wiping operation. In such a case, the second pressing portion 407e presses the blade slider 1003. The blade slider 1003 is assisted to return to the initial position by being pressed by the second pressing portion 407e.

On the left side surface of the main cam 407i, the first pressing portion 407d that can press the blade slider 1003 is formed at a position away from the thick shaft portion 407g. The first pressing portion 407d can press the blade slider 1003 in a case of moving the blade 402 forward. In a case of moving the blade 402 backward, the first pressing portion 407d can slide against the blade slider 1003. The first pressing portion 407d and the second pressing portion 407e are formed at overlapping positions in the width direction (X direction) of the cam unit 407.

The main cam 407i includes the sensor flag 407f that protrudes from the outer peripheral surface of the main cam 407i so as to be hit by light emitted with a predetermined pulse. Specifically, the sensor flag 407f functions as a detected portion whose position is detected by the photo-interruptor 211 (see FIG. 2) having a light emitting element and a light receiving element arranged to face each other. In a case where the sensor flag 407f passes between the light emitting element and the light receiving element, light emitted by the light emitting element with a predetermined pulse is blocked, and the light receiving element can no longer receive light. The angle of rotation of the cam unit 407 is managed by detecting the amount of movement of the sensor flag 407f in a case where the sensor flag 407f is illuminated or not illuminated with light. In the present embodiment, the rotation of the cam unit 407 is thus appropriately controlled.

The first cam 407a, the second cam 407b, and the third cam 407c are provided at the leading end (end on the −X direction side) of the thin shaft portion 407h.

### <Blade Slider 1003>

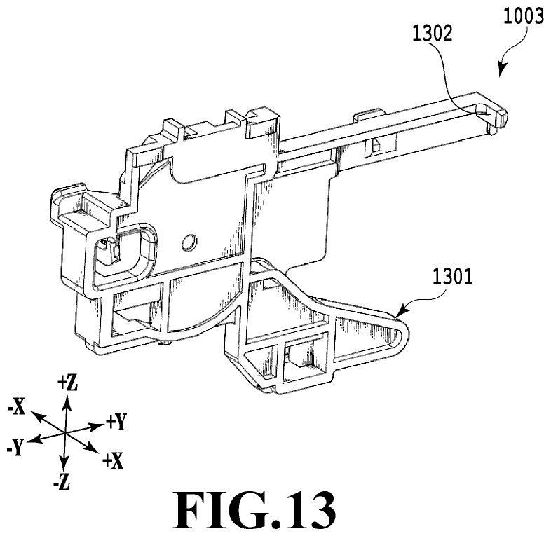

FIG. 13 is a perspective view illustrating an example of the blade slider 1003 applicable to the present embodiment.

As illustrated in FIG. 13, the blade slider 1003 is formed with a curved surface 1301 and a pressed surface 1302. The curved surface 1301 is formed to be tapered toward the rear (+Y direction) from around the center of the member main body. The pressed surface 1302 is formed so as to be able to come into contact with the second pressing portion 407e (see FIG. 12) above the member main body in the vertical direction (+Z direction side).

The curved surface 1301 has a round lower end (end on the −Z direction side). On the forward path of the wiping operation, the first pressing portion 407d (see FIG. 12) presses the lower end of the curved surface 1301, causing the blade slider 1003 to move forward in the −Y direction.

On the return path of the wiping operation, the first pressing portion 407d comes into contact with the tapered portion of the curved surface 1301, and the curved surface 1301 and the first pressing portion 407d slide against each other. The speed at which the blade slider 1003 returns to the initial position is thus controlled. This is to prevent the blade 402 from gaining too much momentum as it is pulled back by the elastic restoring force of the return spring 1005 (see FIGS. 11A and 11B).

On the return path of the wiping operation, it may become difficult to move the blade 402 backward in the +Y direction for some reason. In such a case, the blade 402 is assisted to move backward by the second pressing portion 407e pressing the pressed surface 1302.

### <Wiping Operation>

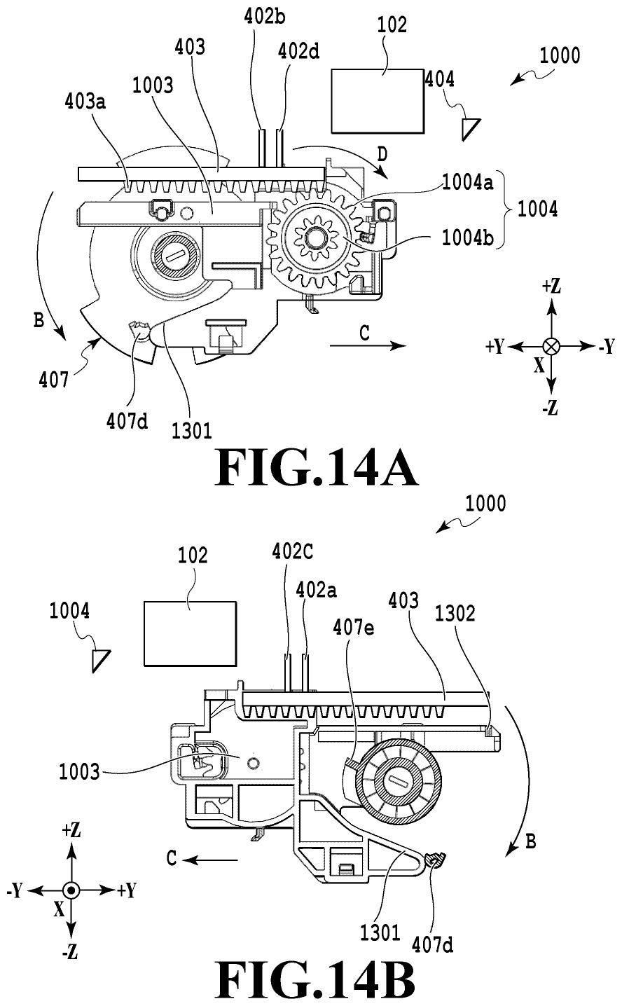

FIGS. 14A and 14B are a left side view and a right side view illustrating an example of the wiping mechanism 1000 applicable to the present embodiment. FIGS. 14A and 14B illustrate a state of the wiping mechanism 1000 at a time before the start of the wiping operation. In FIGS. 14A and 14B, the carriage 102 is located at the home position, which is indicated by a solid line.

As illustrated in FIG. 14A, the blade slider 1003 is biased toward the front (+Y direction) of the apparatus main body by the return spring 1005 (see FIGS. 11A and 11B). In the wiping operation according to the present embodiment, the cam unit 407 rotates in one direction (direction indicated by arrow B in the present embodiment), causing the first pressing portion 407d to press the lower end of the curved surface 1301. The blade slider 1003 moves forward as the first pressing portion 407d presses the lower end of the curved surface 1301. In the present embodiment, the blade slider 1003 moves in the direction indicated by arrow C.

As the blade slider 1003 moves forward, the second gear 1004b meshes with the second rack 401a (see FIG. 10), and the two-stage gear 1004 rotates in one direction (direction indicated by arrow D in the present embodiment). As the two-stage gear 1004 rotates, the blade holder 403 having the first rack 403a meshing with the first gear 1004a moves forward. In the present embodiment, the blade holder 403 moves in the −Y direction.

As the blade holder 403 moves forward, the ejection port surface of the first head cartridge 101a is wiped by the first blade 402a and the third blade 402c. The ejection port surface of the second head cartridge 101b is wiped by the second blade 402b and the fourth blade 402d.

In the present embodiment, the blade cleaner 404 is not located on the flow line of the carriage 102 that reciprocates along the X direction. With this arrangement, the carriage 102 can be prevented from coming into contact with the blade cleaner 404.

As illustrated in FIG. 14B, the second pressing portion 407e is not in contact with the pressed surface 1302 before the wiping operation starts.

### <Blade 402 and Blade Cleaner 404>

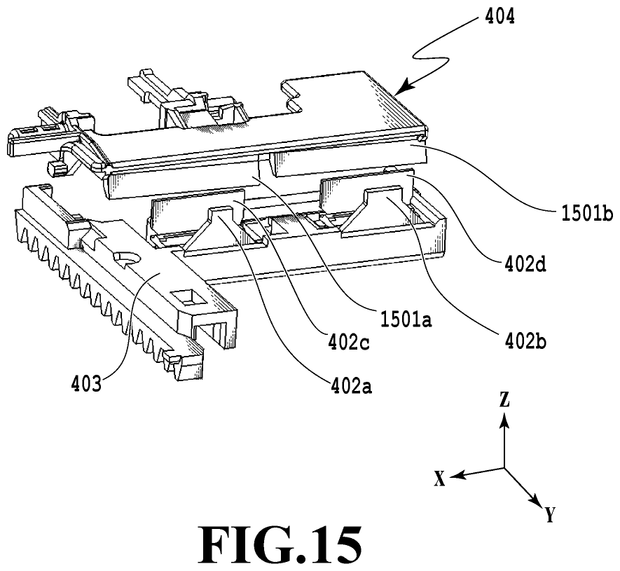

FIG. 15 is a perspective view of the blade 402 and the blade cleaner 404 applicable to the present embodiment, as viewed from the front left. Note that the position of the blade holder 403 illustrated in FIG. 15 is the position after the ejection port surface is wiped by the blade 402 and before the blade 402 comes into contact with the blade cleaner 404.

As illustrated in FIG. 15, the blade cleaner 404 is provided with a first cleaner portion 1501a that can scrape off deposits adhering to the third blade 402c and the first blade 402a. The blade cleaner 404 is provided with a second cleaner portion 1501b that can scrape off deposits adhering to the fourth blade 402d and the second blade 402b. The first cleaner portion 1501a and the second cleaner portion 1501b will be hereinafter referred to as the “cleaner portion 1501” unless there is a particular need to distinguish between the two.

The third blade 402c has a shape wider than the first blade 402a in order to wipe the entire area of the ejection port surface of the first head cartridge 101a. The first blade 402a has a shape narrower than the third blade 402c in order to wipe the vicinity of the ejection port on the ejection port surface of the first head cartridge 101a.

The fourth blade 402d has a shape wider than the second blade 402b in order to wipe the entire area of the ejection port surface of the second head cartridge 101b. The second blade 402b has a shape narrower than the fourth blade 402d in order to wipe the vicinity of the ejection port on the ejection port surface of the second head cartridge 101b.

### <Full Stroke of Blade Driving Mechanism>

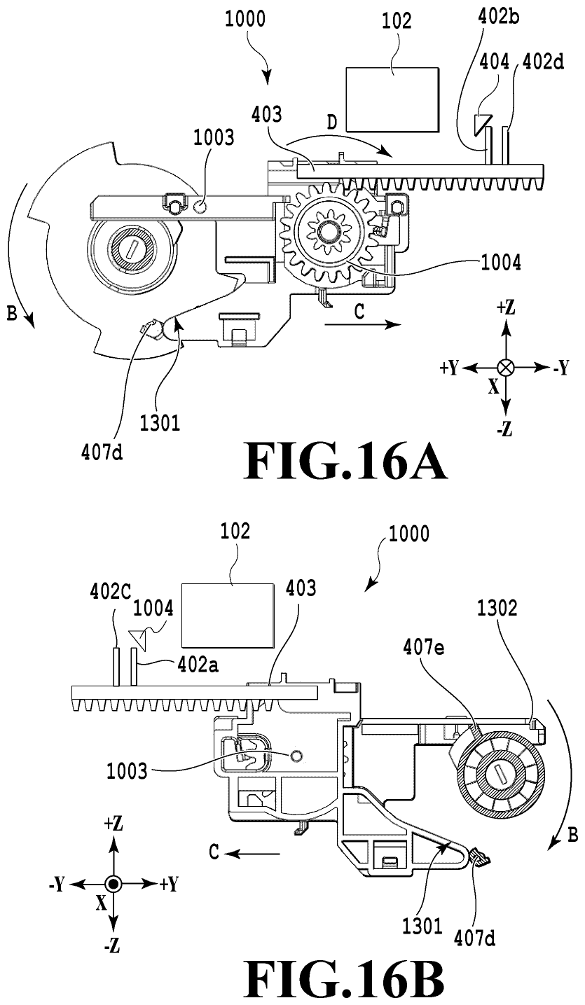

FIGS. 16A and 16B are a left side view and a right side view of the blade holder 403 moved forward to its limit. That is, the blade holder 403 illustrated in FIGS. 16A and 16B is in a full-stroke state.

As illustrated in FIG. 16A, the blade holder 403 further moves forward as the cam unit 407 further rotates in the same direction (direction indicated by arrow B) from the state illustrated in FIG. 14A. The blade 402 temporarily stops as it moves forward to its limit. While the blade 402 temporarily stops, the carriage 102 moves from the home position to the printing area. In the present embodiment, the carriage 102 is located at the home position, which is indicated by the solid line.

As the carriage 102 moves to the printing area, the blade holder 403 returns to the initial position from the full-stroke position. In other words, the wiping operation is switched from the forward path to the return path after full stroke of the blade holder 403.

As illustrated in FIG. 16B, at this point, the second pressing portion 407e is not in contact with the pressed surface 1302.

### <Friction Reduction on Return Path of Wiping Operation>

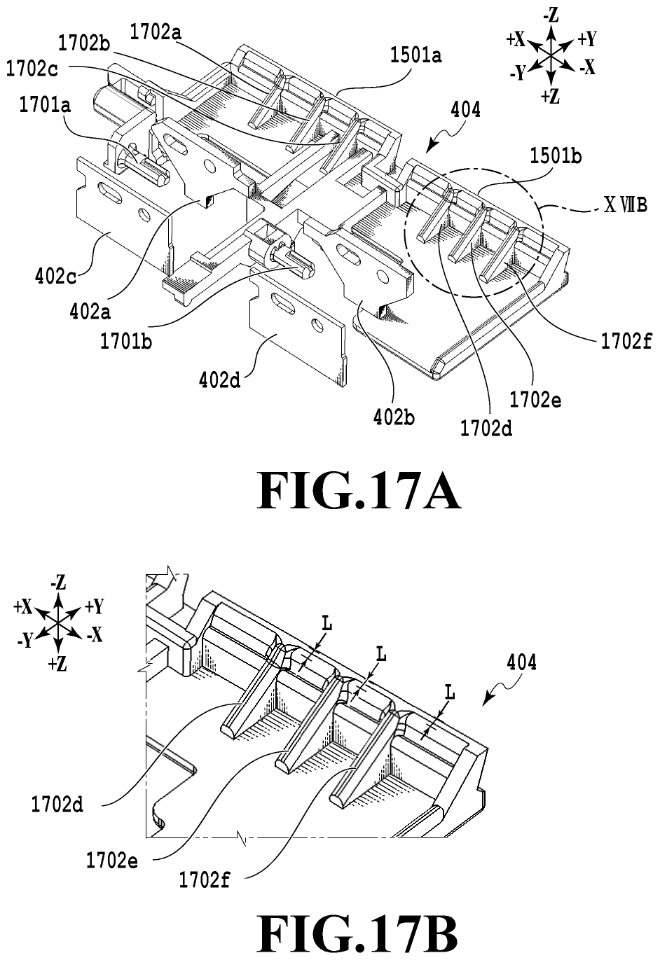

FIG. 17A is a perspective view for explaining a back side configuration of the blade cleaner 404. The positions of the third blade 402c, the first blade 402a, the fourth blade 402d, and the second blade 402b illustrated in FIG. 17A are the positions during full stroke of the blade holder.

As illustrated in FIG. 17A, the blade cleaner 404 is supported by a first rotation shaft 1701a and a second rotation shaft 1701b located on the same axis and configured to extend along the width direction (X direction) of the blade cleaner 404. With such a configuration, in a case where the blade 402 and the blade cleaner 404 come into contact with each other, the blade cleaner 404 can freely rotate about the first rotation shaft 1701a and the second rotation shaft 1701b.

A first rib 1702a, a second rib 1702b, and a third rib 1702c are formed on the back surface (surface facing the −Y direction) of the first cleaner portion 1501a. The first rib 1702a, the second rib 1702b, and the third rib 1702c each have a slope inclined toward the bottom surface (surface facing the −Z direction) of the blade cleaner 404 from the lower end (upper end in FIG. 17A) of the first cleaner portion 1501a.

The second rib 1702b is formed at a position where it can slide against both the first blade 402a and the third blade 402c as the blade 402 moves backward. In the present embodiment, the second rib 1702b is formed between the first rib 1702a and the third rib 1702c. The first rib 1702a and the third rib 1702c are formed at positions where both cannot contact the first blade 402a but can slide against the third blade 402c as the blade 402 moves backward.

A fourth rib 1702d, a fifth rib 1702e, and a sixth rib 1702f are formed on the back surface (surface facing the −Y direction) of the second cleaner portion 1501b. The fourth rib 1702d, the fifth rib 1702e, and the sixth rib 1702f each have a slope inclined toward the bottom surface (surface facing the −Z direction) of the blade cleaner 404 from the lower end (upper end in the example of FIG. 17A) of the second cleaner section 1501b.

The fifth rib 1702e is formed at a position where it can slide against both the second blade 402b and the fourth blade 402d as the blade 402 moves backward. In the present embodiment, the fifth rib 1702e is formed between the fourth rib 1702d and the sixth rib 1702f. The fourth rib 1702d and the sixth rib 1702f are formed at positions where both cannot contact the second blade 402b but can slide against the fourth blade 402d as the blade 402 moves backward.

With such a configuration, on the return path of the blade operation, the back surface of the first blade 402a (surface facing the +Y direction) slides against the second rib 1702b without contacting the first rib 1702a and the third rib 1702c. The back surface (surface facing the +Y direction) of the third blade 402c slides against the first rib 1702a, the second rib 1702b, and the third rib 1702c.

The back surface (surface facing the +Y direction) of the second blade 402b slides against the fifth rib 1702e without contacting the fourth rib 1702d and the sixth rib 1702f. The back surface (surface facing the +Y direction) of the fourth blade 402d slides against the fourth rib 1702d, the fifth rib 1702e, and the sixth rib 1702f.

FIG. 17B is a partially enlarged view of a region XVIIb illustrated in the example of FIG. 17A.

As illustrated in FIG. 17B, the lower ends of the slopes of the fourth rib 1702d, the fifth rib 1702e, and the sixth rib 1702f are located at positions shifted from the lower end of the second cleaner portion 1501b in the forward direction (−Y direction) of the blade holder.

In the present embodiment, the lower end of the slope is located at a position shifted from the lower end of the second cleaner portion 1501b by a certain distance (L) in the forward direction (−Y direction) of the blade holder. Note that the slopes of the first rib 1702a, the second rib 1702b, and the third rib 1702c each have the configuration as that of the fourth rib 1702d, the fifth rib 1702e, and the sixth rib 1702f. The first rib 1702a, the second rib 1702b, the third rib 1702c, the fourth rib 1702d, the fifth rib 1702e, and the sixth rib 1702f will be hereinafter referred to as the “rib 1702” unless there is a particular need to distinguish between them.

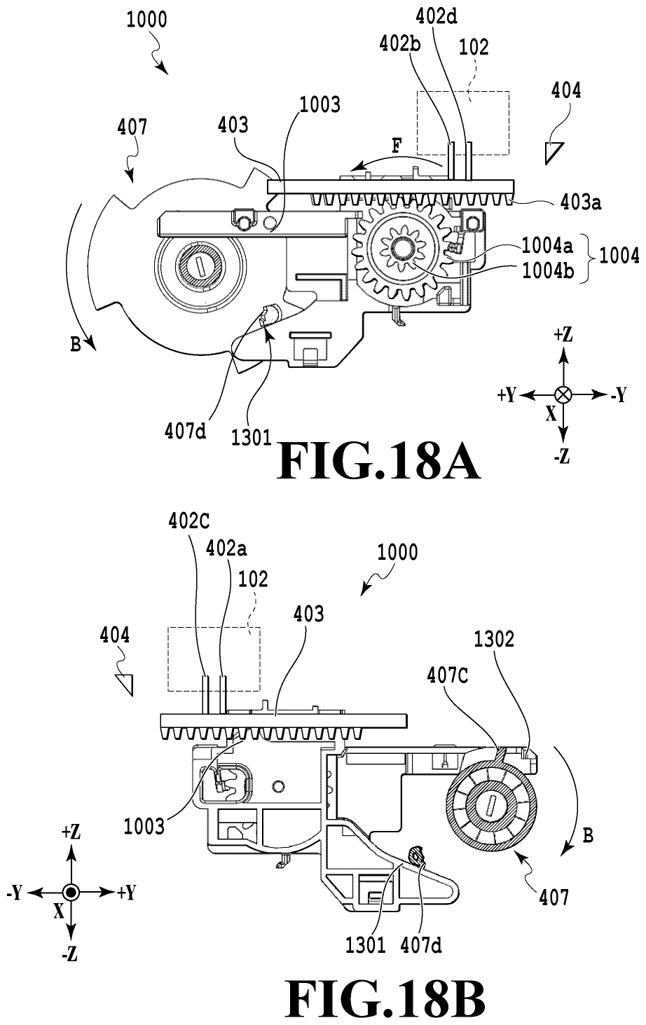

On the return path of the wiping operation according to the present embodiment, the blade holder 403 (see FIGS. 18A and 18B) moves backward while sliding the back surface of the blade 402 against the slope of the rib 1702. With such a configuration, the impact generated when the blade 402 and the blade cleaner 404 collide is released along the slope. Therefore, compared to a configuration in which the back surface of the blade 402 directly collides with the back surface of the cleaner portion 1501, the wiping mechanism 1000 according to the present embodiment can reduce the impact as the blade 402 and the blade cleaner 404 collide.

Furthermore, the blade cleaner 404 rotates about the first rotation shaft 1701a and the second rotation shaft 1701b as the blade 402 and the rib 1702 slide. With such a configuration, the blade cleaner 404 is rotated and lifted as the blade 402 and the blade cleaner 404 collide. The impact of the collision is thus released by rotating the blade cleaner 404. Therefore, the wiping mechanism 1000 according to the present embodiment can reduce the impact as the blade 402 and the blade cleaner 404 collide, compared to a configuration in which the blade cleaner cannot be rotated.

The wiping mechanism 1000 according to the present embodiment is thus configured so that the amount of deflection of the blade during backward movement is minimized. Therefore, compared to a configuration including no rotation shaft, ink adhering to the blade cleaner 404 can be prevented from scattering.

Furthermore, with the configuration according to the present embodiment, the frictional resistance between the blade 402 and the blade cleaner 404 can be suppressed compared to a configuration that does not include the first rotation shaft 1701a, the second rotation shaft 1701b, and the rib 1702. As a matter of course, even if there is no ink between the blade 402 and the blade cleaner 404, the frictional resistance between the blade 402 and the blade cleaner 404 can be suppressed. It is preferable that the number of ribs 1702, the arrangement thereof, or both be determined as appropriate depending on the shape, characteristics, or both of the blade.

As described above, with the wiping mechanism according to the present disclosure, the frictional resistance between the blade 402 and the blade cleaner 404 can be suppressed on the return path of the wiping operation.

Furthermore, as described above, the blade cleaner 404 is not located on the flow line of the carriage 102. This can reduce the clearance between the blade cleaner 404 and the carriage 102 in the height direction (Z direction) as compared to the related art, even if the blade cleaner 404 has the first rotation shaft 1701a and the second rotation shaft 1701b. Therefore, the height of the printing apparatus can be reduced compared to printing apparatuses of the related art while suppressing the frictional resistance between the blade 402 and the blade cleaner 404.

### <Return Path of Wiping Operation>

FIG. 18A is a left side view illustrating an example of the wiping mechanism 1000 on the return path of the wiping operation. Note that the carriage 102 illustrated in FIG. 18A is moved into the printing area, and is thus indicated by a dashed line.

As described above, on the return path of the wiping operation, the blade holder 403 returns to the initial position using the elastic restoring force of the return spring 1005. The first rack 403a of the blade holder 403 meshes with the first gear 1004a of the two-stage gear 1004. As a result, the two-stage gear 1004 rotates in the direction (direction indicated by arrow F) opposite to the direction of its rotation to send out the blade holder 403.

On the other hand, the cam unit 407 continues to rotate in the same direction (direction indicated by arrow B) from the state illustrated in FIG. 16A. As a result, the first pressing portion 407d runs on the curved portion from the lower end of the curved surface 1301 and slides against the curved portion. Specifically, on the return path of the wiping operation according to the present embodiment, the movement speed of the blade slider 1003 and the blade holder 403 as they return to the initial position is controlled by the sliding movement of the first pressing portion 407d and the curved surface 1301.

In the present embodiment, the ink adhering to the blade 402 is thus prevented from scattering as the blade slider 1003 and the blade holder 403 are thrust back by the biasing force of the return spring.

FIG. 18B is a right side view of the wiping mechanism 1000 on the return path of the wiping operation.

As illustrated in FIG. 18B, the second pressing portion 407e does not come into contact with the pressed surface 1302 if there is no abnormality while the blade slider 1003 and the blade holder 403 are returning to the initial position.

### <Return to Initial Position>

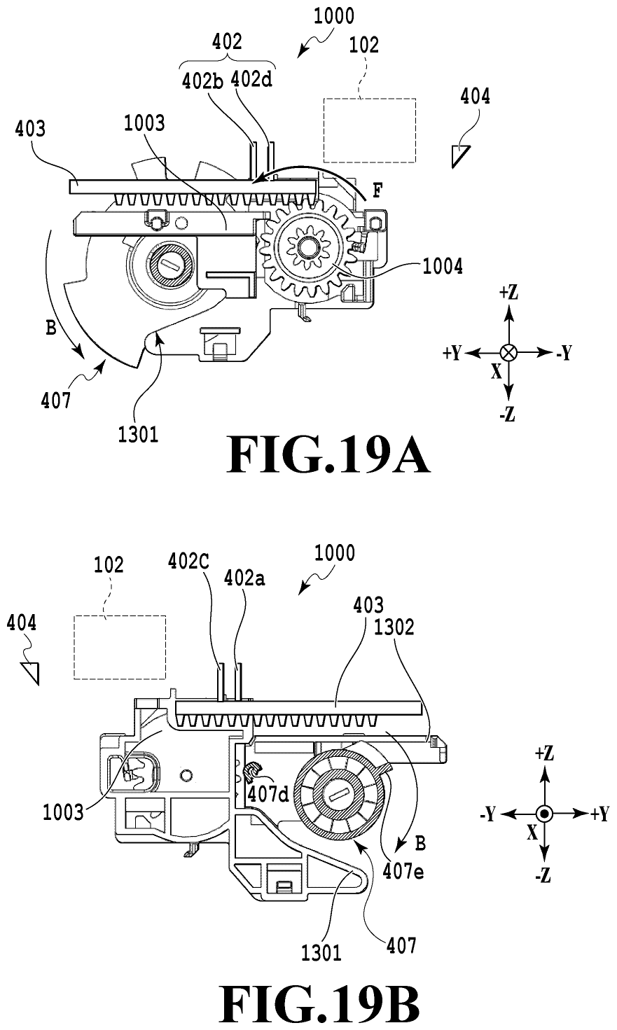

FIG. 19A is a left side view illustrating an example of the wiping mechanism 1000 as the blade slider 1003 and the blade holder 403 are returned to the initial position. Note that the carriage 102 illustrated in FIG. 19A is moved into the printing area, and is thus indicated by a dashed line.

As illustrated in FIG. 19A, if there is no abnormality on the return path of the wiping operation, the blade slider 1003 is returned to the initial position using only the elastic restoring force of the return spring 1005 (see FIGS. 11A and 11B). As a result, the blade 402 is also returned to its initial position. Note that while the blade slider 1003 is returning to the initial position, the two-stage gear 1004 continues to rotate in the direction indicated by arrow F, and the cam unit 407 continues to rotate in the direction indicated by arrow B. Even after the blade holder 403 is returned to the initial position, the blade holder 403 is biased in the +Y direction by the return spring 1005.

FIG. 19B is a right side view of the wiping mechanism 1000 as the blade slider 1003 and the blade holder 403 are returned to the initial position.

As illustrated in FIG. 19B, in a case where the blade slider 1003 and the blade holder 403 are returned to the initial position without occurrence of any abnormality, the second pressing portion 407e does not come into contact with the pressed surface 1302.

### <In Event of Abnormality>

Hereinafter, description is given of a case where the blade 402 can no longer be easily returned to its initial position for some reason. In the present embodiment, description is given assuming that the blade 402 gets caught by the blade cleaner 404 on the return path of the wiping operation, making it difficult for the blade 402 to pass through.

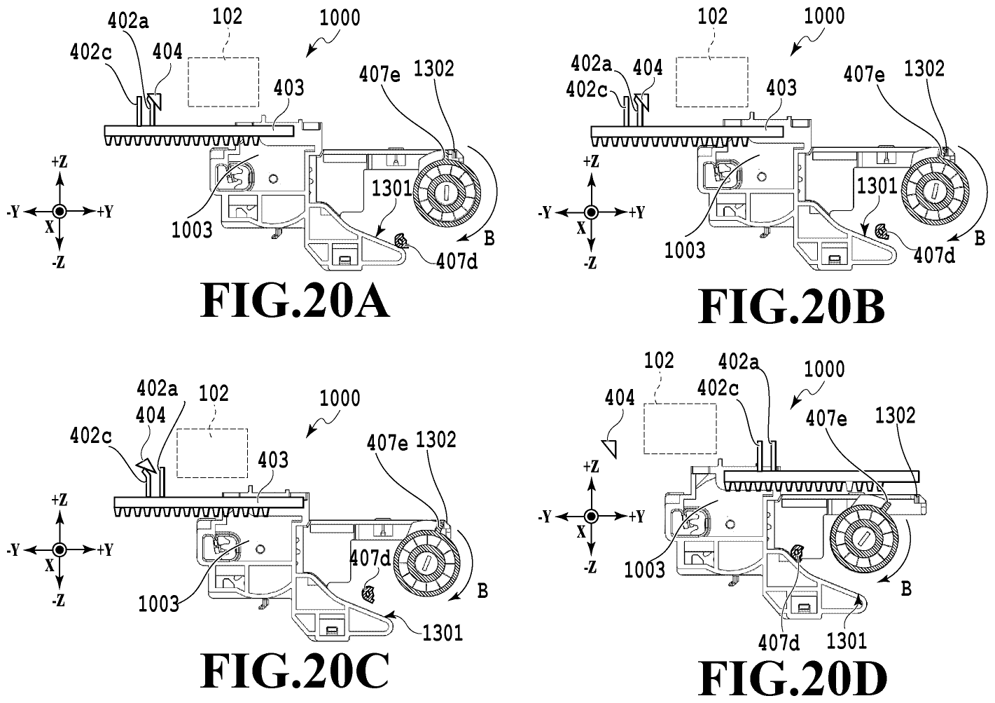

FIGS. 20A to 20D are diagrams illustrating the operation of the wiping mechanism 1000 in the event of an abnormality. Note that the carriage 102 illustrated in FIGS. 20A to 20D is moved into the printing area, and is thus indicated by a dashed line.

As described above, when the wiping operation is performed normally, the second pressing portion 407e does not come into contact with the pressed surface 1302. In the event of an abnormality, however, the second pressing portion 407e presses the pressed surface 1302 and assists the blade 402 to return to the initial position.

As illustrated in FIG. 20A, it is assumed that, on the return path of the wiping operation, the first blade 402a gets caught by the blade cleaner 404, and the blade slider 1003 can no longer be moved backward using only the elastic restoring force of the return spring. Even in such a case, the cam unit 407 continues to rotate in the same direction as illustrated in FIG. 19B (direction indicated by arrow B). Here, the movement of the blade slider 1003 is stopped at the point of occurrence of the abnormality, resulting in a state where the second pressing portion 407e presses the pressed surface 1302.

As illustrated in FIG. 20B, as the cam unit 407 continues to rotate in the same direction (direction indicated by arrow B) from the state illustrated in FIG. 20A, the second pressing portion 407e pushes out the pressed surface 1302 and forcibly moves the blade slider 1003 backward. This leads to a state where the first pressing portion 407d is temporarily separated from the curved surface 1301.

As illustrated in FIG. 20C, as the cam unit 407 further continues to rotate in the same direction (direction indicated by arrow B) from the state illustrated in FIG. 20B, the blade slider 1003 is further moved backward with the second pressing portion 407e pressing the pressed surface 1302. As the blade slider 1003 is further moved backward from the state illustrated in FIG. 20B, the blade 402 passes through the blade cleaner 404.

In the present embodiment, the blade 402 slides against the blade cleaner 404 while rotating the blade cleaner 404. By rotating the blade cleaner 404, the friction between the blade 402 and the blade cleaner 404 is reduced compared to the case where the blade cleaner 404 does not move.

As illustrated in FIG. 20D, as the blade 402 passes the blade cleaner 404, the elastic restoring force of the return spring 1005 moves the blade slider 1003 backward. This causes the curved surface 1301 and the first pressing portion 407d to come into contact again, resulting in a normal operation during backward movement.

As described above, the cam unit 407 according to the present embodiment assists the backward movement of the blade slider 1003 only in the even of an abnormality. That is, in a case where the elastic restoring force of the return spring 1005 alone cannot return the blade slider 1003 and the blade holder 403 to their initial positions, the second pressing portion 407e comes into contact with the pressed surface 1302. Then, by further rotating the cam unit 407 with the second pressing portion 407e pressing the pressed surface 1302, the blade slider 1003 is forcibly moved backward. With such a configuration, the blade 402 can be forcibly returned to the initial position even in the event of an abnormality on the return path of the wiping operation.

Note that the return spring 1005 needs a large elastic restoring force to realize a design that allows the blade 402 to be returned to the initial position using only the elastic restoring force of the return spring 1005 in the event of an abnormality. As described above, the return spring 1005 biases the blade slider 1003 in the +Y direction. Therefore, if the return spring 1005 has an excessive elastic restoring force, a driving load on the conveyance motor 207 (see FIG. 2) used to move the blade holder 403 forward tends to increase. Using the motor that can withstand such a driving load may lead to increased costs.

On the other hand, the wiping mechanism 1000 according to the present embodiment is configured to assist the blade slider 1003 to move backward only in the event of an abnormality. This eliminates the need to excessively increase the elastic restoring force of the return spring 1005. The wiping mechanism 1000 according to the present embodiment can reciprocate the blade 402 by rotating the conveyance motor 207 in one direction.

The wiping mechanism 1000 according to the present embodiment can also reciprocate the blade holder 403 substantially parallel to the ejection port surface. This enables wiping to be performed more reliably than with a blade holder that cannot be reciprocated substantially parallel to the ejection port surface.

In the event of an abnormality on the return path of the wiping operation, the wiping mechanism 1000 according to the present embodiment forcibly moves the blade slider 1003 backward. This allows the blade holder 403 to be returned to the initial position more reliably than with a configuration that does not include the second pressing portion 407e.

As described above, the tube 306 and the tube 311 (see FIG. 9) according to the present embodiment are arranged using the space below the cap 303 in the vertical direction. Therefore, compared to the arrangement in which the tubes extend from the cap along the width direction of the recovery unit and then extends along the side surface of the waste liquid collection unit as in the related art, the arrangement of the tubes 306 and 311 according to the present embodiment contributes to miniaturization of the recovery unit in the width direction.

As described above, the blade cleaner 404 according to the present embodiment is not located on the flow line of the carriage 102. That is, the blade cleaner 404 and the carriage 102 according to the present embodiment are arranged so as not to overlap with each other in the depth direction of the printing apparatus. Therefore, even if the blade cleaner 404 is rotatable, the carriage 102 is not located above the blade cleaner 404 in the vertical direction. This can reduce the height of the printing apparatus compared to the related art while reducing the frictional resistance between the blade 402 and the blade cleaner 404.

The printing apparatus according to the present embodiment can thus maintain the ejection performance without increasing the size of the recovery unit.

### Second Embodiment

Hereinafter, a second embodiment of the technology of the present disclosure will be described with reference to the drawings. In the present embodiment, the cam unit stops the backward movement of the blade holder in the event of an abnormality on the return path of the wiping operation. This prevents a situation where it is difficult for the user to repair on his or her own. In the following description, the same reference numerals will be used for configurations similar to or corresponding to those in the first embodiment and description thereof will be omitted, and differences will be mainly described.

### <Second Cam Unit 2100>

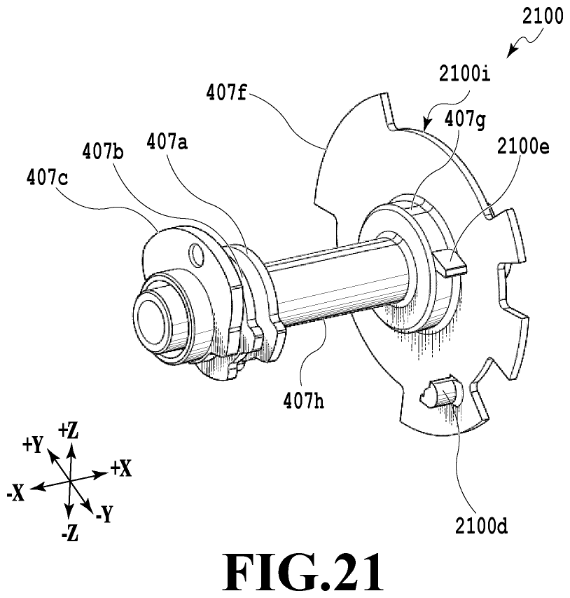

FIG. 21 is a perspective view illustrating a second cam unit 2100 applicable to the present embodiment.

As illustrated in FIG. 21, the second cam unit 2100 includes a thick shaft portion 407g, a thin shaft portion 407h, a first cam 407a, a second cam 407b, and a third cam 407c, as in the first embodiment. In the present embodiment, the second cam unit 2100 includes a second main cam 2100i. The second main cam 2100i includes a third pressing portion 2100d, a fourth pressing portion 2100e, and a sensor flag 407f. Note that the sensor flag 407f has the same configuration as that in the first embodiment.

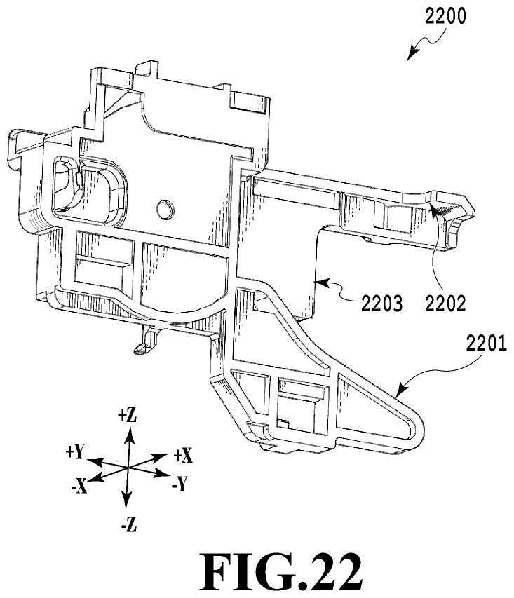

In the present embodiment, in the event of an abnormality on a return path of a wiping operation, the third pressing portion 2100d and the fourth pressing portion 2100e can stop backward movement of a second blade slider 2200 (see FIG. 22) by contacting the second blade slider 2200.

### <Second Blade Slider 2200>

FIG. 22 is a perspective view illustrating the second blade slider 2200 applicable to the present embodiment.

As illustrated in FIG. 22, the second blade slider 2200 is configured to be able to engage and move with the second cam unit 2100 (see FIG. 21). The second blade slider 2200 is formed with a curved surface 2201, a pressed surface 2202, and a vertical surface 2203 extending along the vertical direction (Z direction).

In the present embodiment, when an abnormal load is applied to the blade 402, the third pressing portion 2100d comes into contact with the vertical surface 2203, and the fourth pressing portion 2100e comes into contact with the pressed surface 2202. This stops backward movement of the second blade slider. In the present embodiment, the rotation of the second cam unit 2100 can thus be stopped.

### <Processing in Event of Abnormality>

On the return path of the wiping operation, the carriage 102 is normally located within the printing area. Since the blade 402 does not move within the printing area, the blade 402 is less likely to come into contact with the carriage 102 as it returns to its initial position. However, if the carriage 102 cannot return to the printing area from the home position for some reason, the blade 402 may come into contact with the carriage 102. In the present embodiment, even in such a case, the blade 402 can be returned to the initial position. The following description is given mainly of the processing of returning the blade 402 to its initial position if the blade 402 comes into contact with the carriage 102 on the return path of the wiping operation.

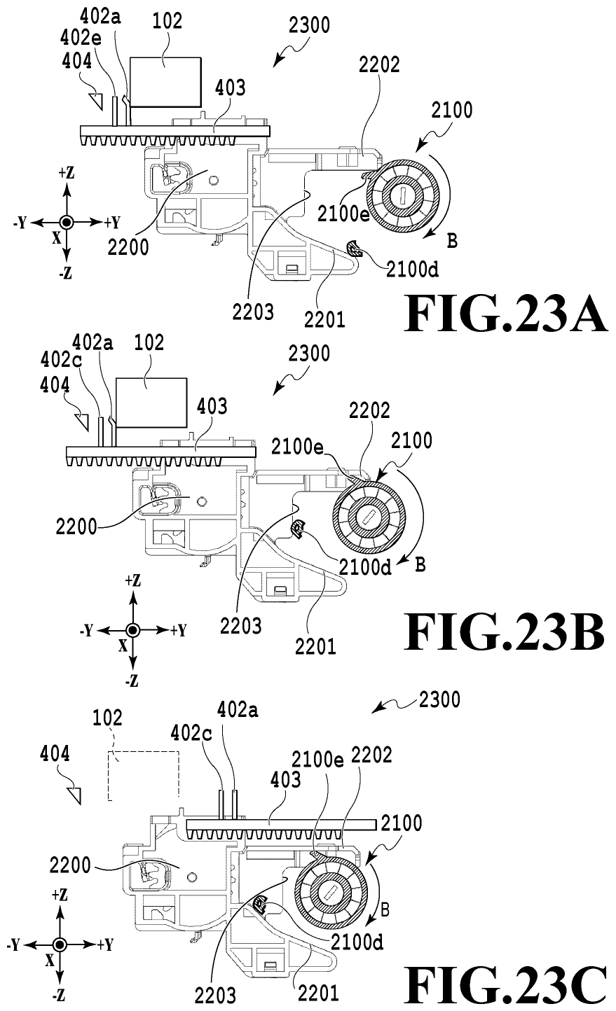

FIGS. 23A to 23C are diagrams illustrating the operation of the second wiping mechanism 2300 in the event of an abnormality. Note that the carriage 102 illustrated in FIGS. 23A and 23B is located at the home position, and is thus indicated by a solid line. Note that the carriage 102 illustrated in FIG. 23C is moved into the printing area, and is thus indicated by a dashed line.

As illustrated in FIG. 23A, it is assumed that, on the return path of the wiping operation, the blade 402 gets caught by the carriage 102, and the second blade slider 2200 can no longer be moved backward using only the elastic restoring force of the return spring 1005. Even in such a case, the second cam unit 2100 continues to rotate in the same direction as illustrated in FIG. 19B (direction indicated by arrow B).

As illustrated in FIG. 23B, since the movement of the blade slider 1003 is stopped at the point of occurrence of the abnormality, the third pressing portion 2100d comes into contact with the vertical surface 2203, and the fourth pressing portion 2100e comes into contact with the pressed surface 2202. In the present embodiment, the backward movement of the second blade slider 2200 and the rotation of the second cam unit 2100 are thus stopped.

In the present embodiment, if the second cam unit 2100 continues to rotate even though the blade 402 is in contact with the carriage 102 on the return path of the wiping operation, there is a possibility that the cap holding portion is lifted and comes into contact with the blade holder 403. Such interference between the cap holding portion 602 and the blade holder 403 makes it difficult for the user to repair on his or her own.

Therefore, in the present embodiment, the fourth pressing portion 2100e comes into contact with the contact surface 2200b and the third pressing portion 2100d comes into contact with the vertical surface 2200c before the cap holding portion and the blade 402 interfere with each other. This can stop the backward movement of the second blade slider 2200.

The fourth pressing portion 2100e is formed to be inclined with respect to the outer peripheral surface of the thick shaft portion 407g of the second cam unit 2100 so that the backward movement of the second blade slider 2200 can be easily stopped. Specifically, a slope is formed such that the outer peripheral surface of the thick shaft portion 407g and the lower surface of the fourth pressing portion 2100e form an acute angle. With such a configuration, upward force acts on the fourth pressing portion 2100e in the vertical direction (+Z direction) as the backward movement of the second blade slider 2200 is stopped. This makes it easier to stop the backward movement of the second blade slider 2200.

As illustrated in FIG. 23C, after the abnormality is resolved, the carriage 102 moves into the printing area from the home position. As the abnormality is resolved, the second blade slider 2200 moves backward using only the elastic restoring force of the return spring 1005.

### <Wiping Processing>

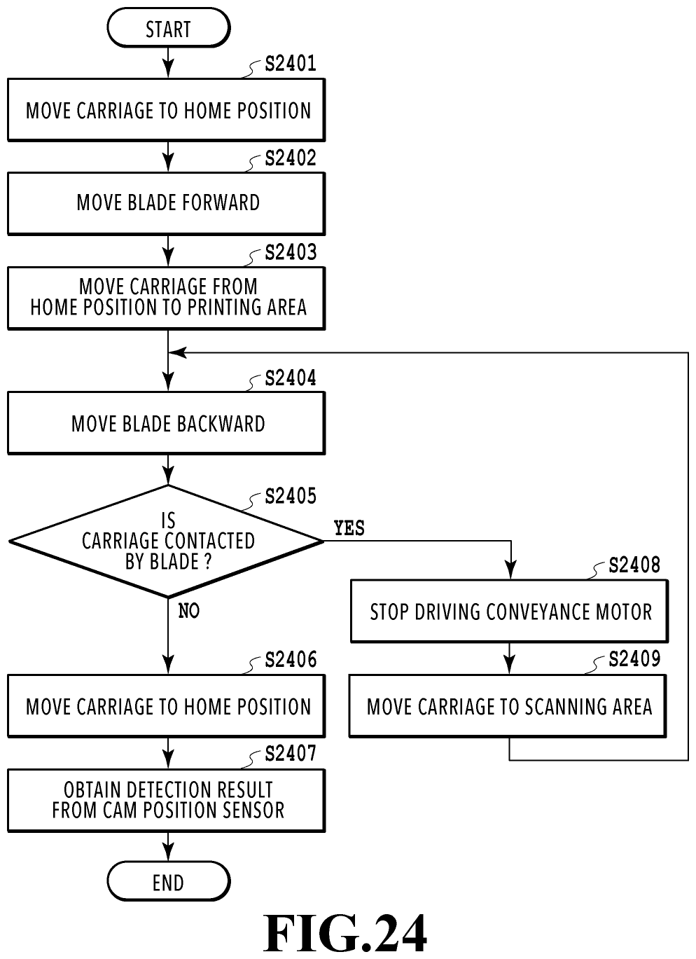

FIG. 24 is a flowchart illustrating an example of wiping processing according to the present embodiment. The processing executed during the wiping operation according to the present embodiment will be described below.

A series of processing illustrated in the flowchart of FIG. 24 is performed by the MPU 201 (see FIG. 2) loading a program code stored in the ROM 202 (see FIG. 2) into the RAM 203 (see FIG. 2) to execute it. A part or all of the functions of the processing illustrated in FIG. 24 may be realized by hardware such as an ASIC or an electronic circuit. Note that the symbol “S” in the description of the processing means a step in the flowchart. The following processing is executed as the MPU 201 receives a recovery operation execution command as a trigger.

In S2401, the MPU 201 moves the carriage 102 (see FIG. 1) to the home position. As the carriage starts moving to the home position, the MPU 201 executes S2402.

In S2402, the MPU 201 moves the blade 402 (see FIG. 4) forward. In other words, the blade 402 wipes the ejection port surface. After the blade is moved forward to its limit (after the blade slider makes a full stroke), the MPU 201 executes S2403.

In S2403, the MPU 201 moves the carriage 102 from the home position to the printing area. The MPU 201 executes S2404 after driving the carriage motor driver 206 (see FIG. 2). Note that S2404 is executed regardless of whether the carriage 102 is moved.

In S2404, the MPU 201 moves the blade 402 backward. As the blade 402 starts moving backward, the MPU 201 executes S2405.

In S2405, the MPU 201 determines whether the carriage 102 is contacted by the blade 402, based on a pulse width modulation (PWM) value of the conveyance motor 207 and the amount of movement of the conveyance motor 207. Note that a known method may be used as the determination method. If the carriage 102 is not contacted by the blade 402 (NO in S2405), the MPU 201 executes S2406. If the carriage 102 is contacted by the blade 402 (YES in S2405), the MPU 201 executes S2408.

In S2406, the MPU 201 moves the carriage 102 to the home position. As the carriage 102 finishes moving to the home position, the MPU 201 executes S2407.

In S2407, the MPU 201 obtains a detection result from the cam position sensor. For example, by obtaining the position of the sensor flag 407f (see FIG. 12) using the photo-interruptor 211 (see FIG. 2), it is possible to determine whether the blade 402 is returned to its initial position. If the detection result from the photo-interruptor 211 indicates that the blade 402 is returned to the initial position, the MPU 201 ends the series of processing.

In S2408, the MPU 201 issues a command to stop driving the conveyance motor 207. As the driving of the conveyance motor 207 is stopped, the MPU 201 executes S2409.

In S2409, the MPU 201 moves the carriage 102 to the printing area. As the carriage 102 is moved into the printing area, the MPU 201 repeats the processing from S2404.

The wiping processing according to the present embodiment has been described above. As described above, with the printing apparatus according to the present embodiment, if the carriage 102 is contacted by the blade 402 on the return path of the wiping operation, the backward movement of the second blade slider 2200 can be stopped by rotating the second cam unit 2100. This prevents the cap holding portion 602 from operating before the abnormality is resolved. With such a configuration, the same effects as in the first embodiment can be achieved.

### Other Embodiments

The present disclosure provides a system or an apparatus through a network or a storage medium with a program to implement one or more functions of the embodiments described above. One or more processors in a computer of the system or apparatus can also read and execute the program to implement one or more functions. Alternatively, a circuit (for example, ASIC) can also be used to implement one or more functions.

The printing apparatus according to the present disclosure can maintain ejection performance without increasing the size of the recovery unit.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-122835, filed Jul. 27, 2023 which are hereby incorporated by reference wherein in its entirety.

What is claimed is:

1. A printing apparatus comprising:
a cap configured to cover an ejection port surface having an ejection port formed therein to eject a liquid;
a cap holding portion configured to movably hold the cap between a position where the cap contacts the ejection port surface and a position where the cap does not contact the ejection port surface;
a suction unit configured to suck the liquid from the cap;
a collection unit configured to collect the liquid sucked by the suction unit;
a first channel connecting the cap and the suction unit;
a second channel connecting the suction unit and the collection unit; and
a channel holding portion configured to hold a part of the first channel and a part of the second channel, wherein
in top view, a part of the first channel and a part of the second channel are disposed at positions overlapping with the cap holding portion.

2. The printing apparatus according to claim 1, wherein
the channel holding portion includes an upper plate and a lower plate arranged in a vertical direction, and
a part of the first channel and a part of the second channel are fixed by being sandwiched between the upper plate and the lower plate.

3. The printing apparatus according to claim 2, wherein
the upper plate has a tray part configured to receive a liquid dripping from the cap, and
in top view, the tray part is disposed at a position overlapping with the cap.

4. The printing apparatus according to claim 1, wherein
the cap holding portion and the suction unit are arranged in positions lined up along a first direction,
the first channel extends along the first direction, and
the second channel includes a portion disposed in parallel with the first channel along the first direction from the suction unit, and a portion separated from the channel holding portion and connected to the collection unit.

5. The printing apparatus according to claim 4, wherein
a part of the first channel and a part of the second channel extend along the first direction in a horizontal plane, and are arranged along a second direction intersecting with the first direction.

6. The printing apparatus according to claim 4, wherein
the collection unit, the cap holding portion, and the suction unit are arranged in this order along the first direction.

7. The printing apparatus according to claim 5, wherein
the first channel and the second channel are arranged within the range of the channel holding portion in the second direction.

8. The printing apparatus according to claim 1, further comprising:
a cam configured to perform a rotation operation; and
an arm having an end portion configured to slide against the cam and fixed to the cap holding portion, wherein
by rotating the cam in one direction, the rotation operation is converted into an elevating and lowering operation of the cap holding portion, and
the ejection port surface is covered as the cap holding portion is elevated, and the cap is separated from the ejection port surface as the cap holding portion is lowered.

9. The printing apparatus according to claim 1, wherein
the cap includes a first cap for containing black ink and a second cap for containing color ink,
the first channel includes a first tube connecting the first cap and the suction unit, and a second tube connecting the second cap and the suction unit, and
the second channel includes a third tube and a fourth tube connecting the suction unit and the collection unit.

10. The printing apparatus according to claim 1, wherein
the first channel includes a space to temporarily store the liquid.

11. The printing apparatus according to claim 1, further comprising:
a printing head having the ejection port surface.

12. The printing apparatus according to claim 5, further comprising:
a conveyance unit configured to convey a printing medium along the first direction; and
a carriage mounted with a printing head having the ejection port surface and configured to reciprocate along the second direction.

13. The printing apparatus according to claim 12, wherein
the printing head has a storage portion to store a liquid, and is detachable from the carriage.
